(19) United States
(12) Patent Application Publication
(10) Pub. No.: US 2024/0256959 A1
(43) Pub. Date: Aug. 1, 2024

(54) BIAS DETECTION IN MACHINE LEARNING TOOLS

(71) Applicant: ORACLE INTERNATIONAL CORPORATION, Redwood Shores, CA (US)

(72) Inventors: Keyang RU, Kirkland, WA (US); Kenneth P. BACLAWSKI, Waltham, MA (US); Richard P. SONDEREGGER, Dorchester, MA (US); Dieter GAWLICK, Palo Alto, CA (US); Anna CHYSTIAKOVA, Palo Alto, CA (US); Guang Chao WANG, San Diego, CA (US); Matthew T. GERDES, Oakland, CA (US); Kenny C. GROSS, Escondido, CA (US)

(21) Appl. No.: 18/226,522

(22) Filed: Jul. 26, 2023

Related U.S. Application Data
(60) Provisional application No. 63/442,509, filed on Feb. 1, 2023.

(51) Int. Cl. G06N 20/00

(52) U.S. Cl. CPC G06N 20/00

(57) ABSTRACT

Systems, methods, and other embodiments associated with detecting unfairness in machine learning outcomes are described. In one embodiment, a method includes generating outcomes for transactions with a machine learning tool to be tested for bias. Then, actual values for a test subset of the outcomes that is associated with a test value for a demographic classification are compared with estimated values for the test subset of outcomes. The estimated values are generated by a machine learning model that is trained with a reference subset of the outcomes that are associated with a reference value for the demographic classification. The method then detects whether the machine learning tool is biased or unbiased based on dissimilarity between the actual values and the estimated values for the test subset of the outcomes. The method then generates an electronic alert that the ML tool is biased or unbiased.

### CROSS REFERENCE TO RELATED APPLICATIONS

This disclosure claims the benefit of U.S. Provisional Patent Application serial number “63/442,509” filed Feb. 1, 2023, titled “DETECTION OF UNFAIRNESS IN MACHINE LEARNING OUTCOMES”, having inventors: Keyang Ru, Kenneth P. Baclawski, Richard P. Sonderegger, Dieter Gawlick, Anna Chystiakova, Guang Chao Wang, Matthew T. Gerdes, and Kenny C. Gross, and assigned to the present assignee, which is incorporated by reference herein in its entirety.

### BACKGROUND

All too often, automation, artificial intelligence (AI), and machine learning (ML) tools and techniques threaten the rights of people, limit opportunities afforded people, and prevent equitable access of people to resources or services. For example, algorithmic discrimination occurs when automated systems contribute to unjustified different treatment or impacts disfavoring people based on their race, color, ethnicity, sex (including pregnancy, childbirth, and related medical conditions, gender identity, intersex status, and sexual orientation), religion, age, national origin, disability, veteran status, genetic information, or any other demographic classification protected by law.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a fairness assessment system associated with fairness assessment for continuous decision evaluations of machine learning outcomes.

FIG. 2A illustrates one embodiment of a fairness assessment method applied to detecting unfairness or bias in machine learning outcomes.

FIG. 2B illustrates one embodiment of a fairness assessment method applied to certifying fairness or non-bias in machine learning outcomes.

FIG. 2C illustrates one embodiment of a fairness assessment method applied to determining a status of whether machine learning outcomes are fair (non-biased) or unfair (biased).

FIG. 3 illustrates one embodiment of a fairness assessment method (or framework) associated with fairness assessment for continuous decision evaluations of machine learning outcomes.

FIG. 4 illustrates two plots of time series of outcomes, a first plot for outcome sequence #1 and a second plot for outcome sequence #2 that are associated with fairness assessment for continuous decision evaluations of machine learning outcomes.

FIG. 5 illustrates an embodiment of a computing system configured with the example systems and/or methods disclosed.

### DETAILED DESCRIPTION

Systems, methods, and other embodiments are described herein that provide fairness assessment for continuous decision evaluations of machine learning outcomes. In one embodiment, a fairness assessment system employs ML anomaly detection models to automatically detect when and in what way an automation, AI, or ML tool or technique is unfair or inequitable to specific classes of persons. By performing proactive fairness (equity) assessments of the automation, AI, and ML tools and techniques using the fairness system, individuals and communities may be protected from algorithmic discrimination, and automation, AI, and ML tools and techniques may be designed and used in an equitable way. For example, fairness assessments may be performed as part of system design when using automation, AI, or ML tools or techniques. For convenience, automation, AI, and ML tools and techniques may be referred to herein collectively as “ML tools”.

In one embodiment, the fairness assessment system leverages the fact that a truly “fair” ML tool will produce similar outcome determinations for similar transactions regardless of demographic class of the parties involved. Therefore, an ML anomaly detection model trained using the inputs and corresponding outcomes from an ML tool for one demographic class should predict outcomes for another demographic class not substantially different from the outcomes produced by the ML tool for the other demographic class, provided that the ML tool is unbiased or “fair”. Where ML tool outcomes substantially differ from ML anomaly detection estimates of the outcomes, the ML tool is in some way biased with respect to whichever demographic class was used to train the ML anomaly detection model. Conversely, where the ML tool outcomes do not substantially differ from the ML estimates, the ML tool may be certified to be free of bias with respect to whichever demographic class was used to train the ML anomaly detection model. The level of difference that is tolerable may be configured based on the end application of the ML tool.

In one embodiment, the fairness assessment system improves the technology of automation, AI, and ML by automatically detecting latent or emerging unfairness or bias in an automation, AI, or ML tool or technique. For example, the fairness assessment system may detect when an ML tool gives better outcomes to men over women, to the young over the old, to one ethnicity over another, even when the preferential or prejudicial treatment may not be immediately apparent. In one embodiment, the fairness assessment system further improves the technology of automation, AI, and ML by automatically tracing detected unfairness to its root cause. In one embodiment, the fairness assessment system also improves the technology of automation, AI, and ML by automatically certifying that an automation, AI, or ML tool or technique is free of (or has) unfairness or bias within a user-specified confidence level, enabling compliance with regulatory mandates against algorithmic discrimination.

In one embodiment, the fairness assessment system tests a ML tool for bias by using the ML tool to produce outcomes for a set of transactions. The outcomes are split into subsets based on discrete values for a demographic classification, for example, a subset for male and a subset for female with reference to the demographic classification of sex. An ML anomaly detection model is used to generate estimates of the outcomes for one of the subsets. The ML anomaly detection model is trained to produce the estimates using another of the subsets. For example, the ML anomaly detection model is trained with the subset of outcomes for women, and used to generate estimates for the subset of outcomes for men. The estimates of the outcomes are compared to actual values for the outcomes. For example, the estimates of the outcomes of transactions performed by men (where the estimates are made as if the transactions were performed by women) are compared to the actual outcomes of the transactions performed by men. The estimated and actual outcomes should be substantially similar, for example, where the distributions of estimated and actual outcomes are unimodal. If the estimated and actual outcomes are dissimilar, unfairness is detected in the ML tool. An alert is then generated that the ML tool generates unfair outcomes with respect to the demographic classification (e.g., with respect to sex). If, on the other hand, the estimated and actual outcomes are similar, unfairness is confirmed to be absent with respect to the demographic classification, and an alert certifying the absence of bias is produced accordingly.

It should be understood that no action or function described or claimed herein is performed by the human mind, and cannot be practically performed in the human mind. An interpretation that any action or function described or claimed herein can be performed in the human mind is inconsistent with and contrary to this disclosure.

### Definitions

As used herein, the term “time series” refers to a data structure in which a series of data points (such as observations or sampled values) are indexed in time order. In one embodiment, the data points of a time series may be indexed with an index such as a point in time described by a time stamp and/or an observation number. As used herein, the terms “time series signal” and “time series” are synonymous. For example, a time series is one “column” or sequence of observations over time from one of several variables for a transaction.

As used herein, the term “vector” refers to a data structure that includes a set of data points (such as observations or sampled values) from multiple time series at one particular point in time, such as a point in time described by a time stamp, observation number, or other index. For example, a “vector” is one row (timestamp) of observations from all S variables involved in a transaction (e.g., including both input variables that describe the transaction and categorical variables that describe the person).

As used herein, the term “time series database” refers to a data structure that includes one or more time series that share an index (such as a series of points in time, time stamps, time steps, or observation numbers) in common. As an example, time series may be considered “columns” of a time series database, and vectors may be considered “rows” of a time series database. For example, a database or collection of transactions may be arranged or indexed in order of a recorded time for the transaction, thus making a time series database of the transactions.

As used herein, the term “transaction” refers to an event involving a person about which an ML tool is to determine an outcome based on a number of input variables that describe the event and categorical variables that describe the person. In one embodiment, a transaction refers to a unit of data representing a collection of information items about one event involving the person. The transaction or event may be described with an individual time series vector or observation. The time series vector for the transaction may include the input variables that provide the basis for the outcome determination by the ML tool, as well as categorical variables that describe demographic classifications or characteristics of the individual(s) involved in the transaction. For example, an ML tool may be used to perform transactions of determining an outcome of how soon to admit a patient presenting symptoms of dangerous conditions, and be provided with input variables that include temperature, blood pressure, heart rate, and examination date, and categorical variables that include name, sex, race, veteran status, and residence location of the patient. In one embodiment, the fairness assessment system can determine whether the speed of admission is unfair or biased based on name, sex, race, veteran status, or residence location of the patient.

The terms “fair” and “unfair” are generally used herein interchangeably with “unbiased” and “biased”, respectively. But, to be clear, the fairness assessment systems and methods described herein operate to discover a statistical bias with respect to various metadata parameters (categorical variables), or to certify an absence of statistical bias. The fairness assessment systems and methods described herein do not make a qualitative moral or ethical judgment about what is “fair” or “unfair” but only whether an outcome contains a quantitative bias relative to another set of outcomes. Whether a bias is “unfair”, or a lack of bias is “fair” is a subjective matter of interpretation that may vary based on the end use of the ML tool under test.

### —Example Fairness Assessment System—

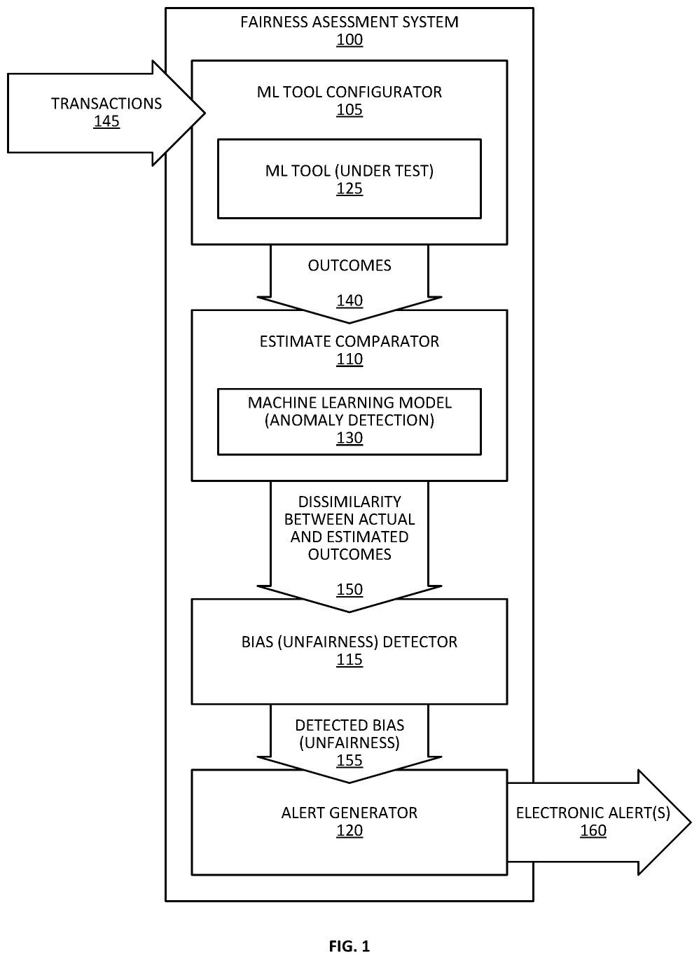

FIG. 1 illustrates one embodiment of a fairness assessment system 100 associated with fairness assessment for continuous decision evaluations of machine learning outcomes. Fairness assessment system 100 includes components for detecting whether or not an ML tool under test includes unfairness or bias. Components of fairness assessment system 100 may include an ML tool configurator 105, an estimate comparator 110, a bias (unfairness) detector 115, and an alert generator 120. ML tool configurator 105 may include an ML tool 125 that is under test for unfairness. Estimate comparator 110 may include a machine learning model 130, such as an ML anomaly detection model. In one embodiment each of these components 105, 110, 115, 120, 125, and 130 of fairness assessment system 100 may be implemented as software executed by computer hardware. For example, components 105, 110, 115, 120, 125, and 130 may be implemented as one or more intercommunicating software modules, routines, or services for performing the functions of the components described herein.

In one embodiment, ML tool configurator 105 is configured to generate outcomes 140 for a set of transactions 145 using ML tool 125. ML tool 125 is under test to detect unfairness. In one embodiment, transactions 145 may be received from a database such as a time series database of transactions. In one embodiment, estimate comparator 110 compares actual values for a test subset of the outcomes 140 with estimated values for the test subset of the outcomes 140. The test subset of the outcomes 140 is associated with a test value for a demographic classification (e.g., a value of “Brazil” for a demographic classification of “National Origin”). The estimated values for the outcomes 140 are generated by a machine learning model 130. Machine learning model 130 is trained with a reference subset of the outcomes 140. The reference subset of the outcomes 140 is associated with a reference value for the demographic classification (e.g., a value of “United States” for the demographic classification of “National Origin”). In one embodiment, bias detector 115 detects unfairness in the ML tool 125 based on dissimilarity between actual and estimated outcomes 150 for the test subset of the outcomes. In response to the detected bias (unfairness) 155, alert generator 120 generates an electronic alert 160 that the ML tool 125 generates outcomes 140 that are unfair with respect to the demographic classification.

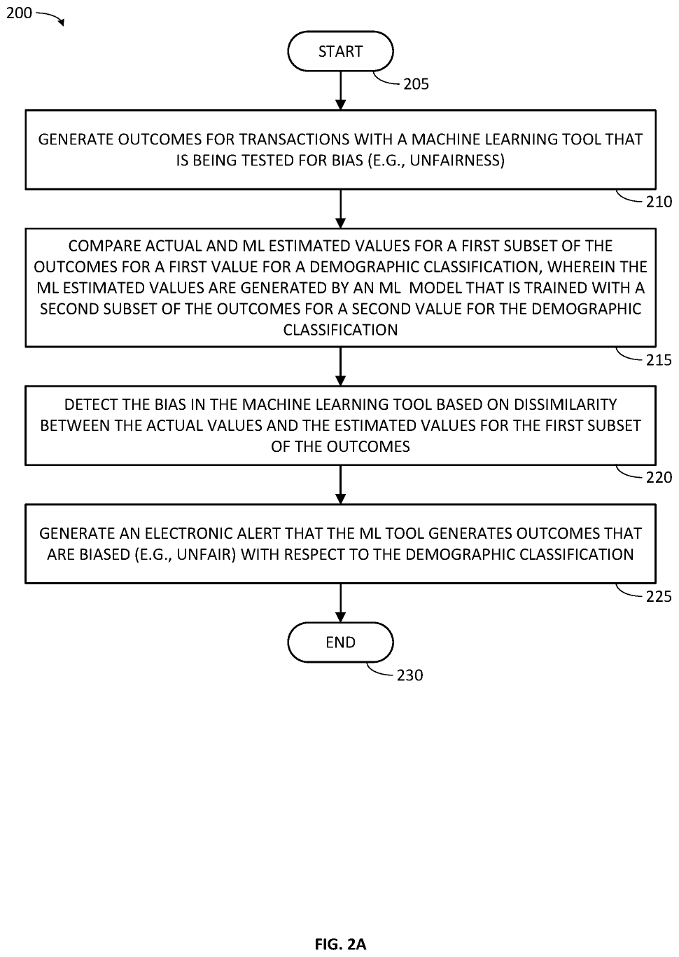

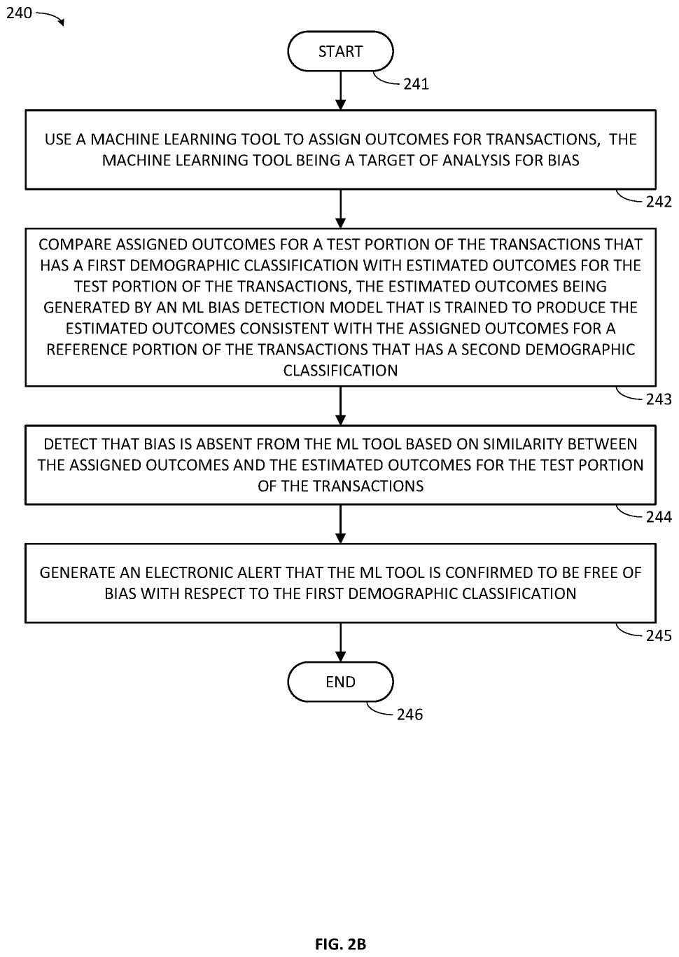

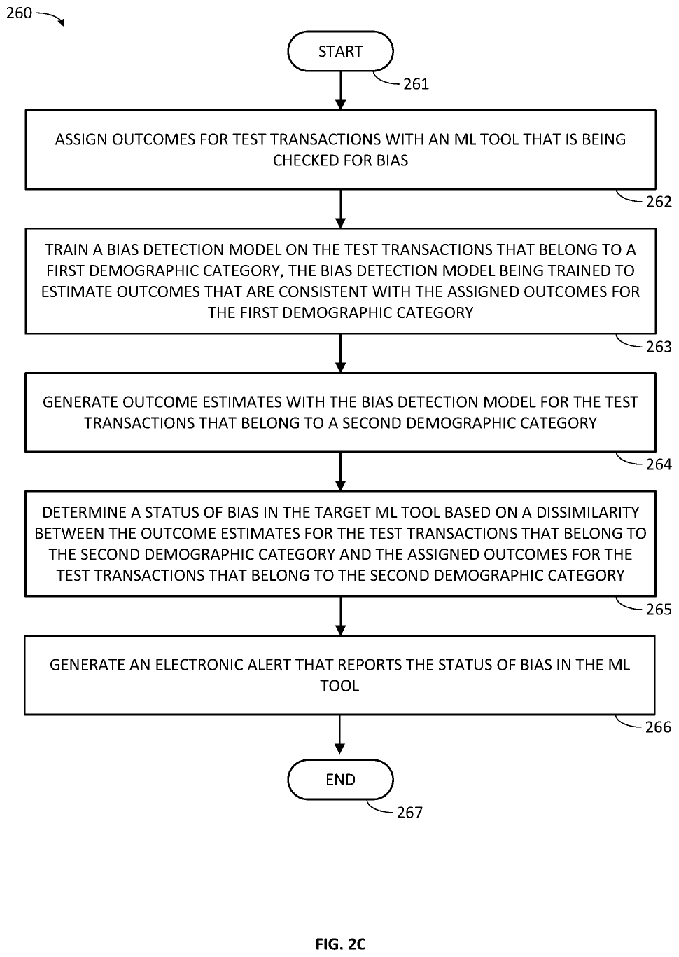

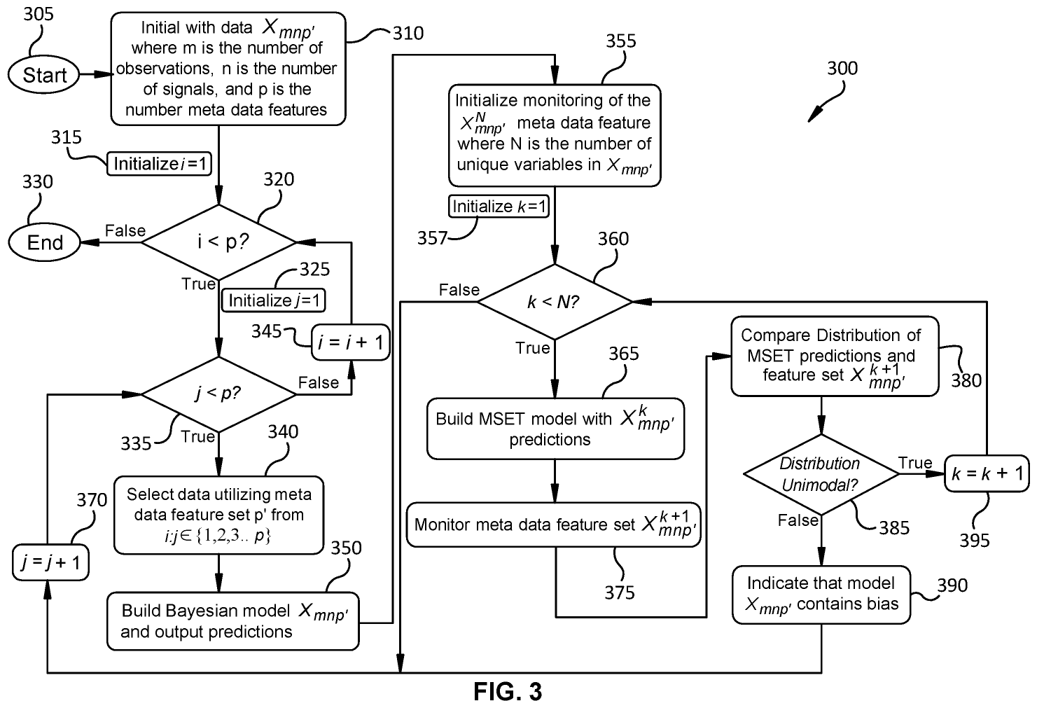

Further details regarding fairness assessment system 100 are presented herein. In one embodiment, the operation of fairness assessment system 100 will be described with reference to example fairness assessment methods 200, 240, 260, and 300 shown in FIGS. 2A-2C and 3.

### —Example Fairness Assessment Method—Detecting Unfairness—

FIG. 2A illustrates one embodiment of a fairness assessment method 200 associated with fairness assessment for continuous decision evaluations of machine learning outcomes. In fairness assessment method 200, ML fairness assessment techniques are applied to detect unfairness—that is, the presence of bias—in an ML tool under test. As an overview, in one embodiment, fairness assessment method 200 generates outcomes of transactions with a machine learning tool under test. Fairness assessment method 200 then splits the outcomes based on values for a demographic classification (e.g., outcomes for veterans split from outcomes for non-veterans, outcomes for Californians split from outcomes for Ohioans and from outcomes for Massachusettsians, etc.). Assessment method 200 trains an ML model with one of the subsets of outcomes. And, assessment method 200 compares actual values and ML-estimated values for outcomes belonging to another one of the subsets of outcomes. Because the ML model was trained with outcomes generated by the ML tool for one demographic class, and the ML model is generating estimated outcomes for another demographic class, bias or unfairness in the outcomes generated by the ML tool becomes apparent when the estimates and actual values for the outcomes are dissimilar. Therefore, fairness assessment method 200 detects unfairness in the ML tool based on dissimilarity between the estimates and actual values. Fairness assessment method 200 then generates an electronic alert that the ML tool is unfair in response to detecting the unfairness. The alert may indicate the demographic classification where the unfairness occurs.

In one embodiment, fairness assessment method 200 initiates at START block 205 in response to an fairness assessment system (such as fairness assessment system 100) determining one or more of (i) that a fairness assessment system has been instructed to evaluate the fairness of a particular ML tool; (ii) that an instruction to perform fairness assessment method 200 on an ML tool with a set of time series readings has been received (iii) a user or administrator of a fairness assessment system has initiated fairness assessment method 200; (iv) it is currently a time at which fairness assessment method 200 is scheduled to be run; or (v) that fairness assessment method 200 should commence in response to occurrence of some other condition.

In one embodiment, decision evaluations of machine learning outcomes from the ML tool may be made continuous or continual by repeated or regular fairness assessment. For example, iteration or repetition of the fairness assessment method 200 (or other bias detection/certification) is performed automatically upon (in response to) training, retraining, replacement, update, or other change to the ML tool under test. Or, for example, fairness assessment of the ML tool may be repeated at a scheduled interval. In this way, the fairness assessment methods, systems or other embodiments described herein provide autonomous detection of the introduction of bias into the ML tool and/or certification of fairness for the ML tool on a continual, ongoing basis.

In one embodiment, a computer system configured by computer-executable instructions to execute functions of fairness assessment system 100 executes fairness assessment method 200. Following initiation at start block 205, fairness assessment method 200 continues to process block 210.

At process block 210, fairness assessment method 200 generates (or otherwise accesses) outcomes for transactions with a machine learning (ML) tool that is being tested for bias or unfairness. Unfairness in a ML tool may be discovered by analysis of transaction outcomes (such as outcomes 140) produced by the ML tool. Accordingly, the ML tool is operated to process transactions (such as those in set of transactions 145) and generate outcomes (also referred to as predictions or estimates) of a decision of how to proceed with the transaction. The ML tool is configured to generate outcomes for a particular type of transaction. For example, the ML tool may be configured to generate interest rates for loan applications as outcomes. The fairness assessment method 200 provides the ML tool with a set of transactions of the type that the ML tool is configured to process. The fairness assessment method 200 executes the ML tool to generate outcomes to the transactions. The transactions may be associated with times, for example dates of a loan application. Thus, the set of transactions may make up a time series of transactions, and the outcomes a time series of outcomes, each indexed by time associated with the transaction and corresponding outcome. In one embodiment, the activities of process block 210 are performed by ML tool configurator 105.

At process block 215, fairness assessment method 200 compares actual values for a test subset of the outcomes that is associated with a test value for a demographic classification with estimated values for the test subset of outcomes. The estimated values are generated by a machine learning model that is trained with a reference subset of the outcomes that are associated with a reference value for the demographic classification. In one embodiment, the test subset and reference subset are complementary subsets, for example, the reference subset may include outcomes associated with a demographic classification, and the test subset may include outcomes not associated with the demographic group. The outcomes may be divided into the test and reference subset based on a value of a demographic classification. For example, outcomes may be split into a test subset of outcomes for transactions performed by non-veterans, and a reference subset of outcomes for transactions performed by veterans in a demographic classification of veteran status. The demographic classifications may also be referred to herein as metadata features or categorical variables (CatVars). The demographic classifications are provided as values for CatVars or metadata features, as discussed in detail herein.

A machine learning model (e.g., machine learning model 130), such as an ML anomaly detection model (e.g., MSET) may be trained using the reference set of outcomes. The reference set of outcomes are associated with a reference demographic class (or reference value for a demographic classification). Thus, the ML anomaly detection model is trained to generate estimates of outcomes as if the transactions are performed for a member of the reference demographic class. Additional detail on training the ML anomaly detection model and monitoring with the anomaly detection model is described below with reference to blocks 365-355 and under the heading “Overview of Multivariate ML Anomaly Detection”.

The trained machine learning model (also referred to herein as a bias detection model) is then used to monitor the test set of outcomes. The test set of outcomes are associated with a test demographic class (or test value for a demographic classification). The machine learning model produces estimates of what the outcomes in the test set of outcomes are expected to be, if the transaction were performed for a member of the reference demographic class instead of for a member of the test demographic class. Thus, this surveillance of or monitoring results of the ML tool under test with a bias detection model shows an extent to which the results from the ML tool are dissimilar to what would be expected if the model is unbiased. Bias is detected when the trained machine learning model (bias detection model) produces estimates so divergent as to trigger a fault detection test. Additional detail regarding monitoring the outcomes is described below, for example with reference to block 375 of method 300 and under the heading “Overview of Multivariate ML Anomaly Detection”. In one embodiment, the activities of process block 215 are performed by estimate comparator 110.

At process block 220, fairness assessment method 200 detects the unfairness or bias (e.g., detected bias 155) in the machine learning tool based on dissimilarity between the actual values and the estimated values for the test subset of the outcomes (e.g., dissimilarity between actual and estimated outcomes 150). In one embodiment, the dissimilarity is produced or generated as residuals (differences) between the actual and estimated outcomes. Where there is no unfairness between the reference set of outcomes and the test set of outcomes, there will be little to no dissimilarity between the actual values (assigned by the ML tool) and ML-estimated values (generated by the bias detection model) for the outcomes. That is, the residuals will be low where there is little unfairness or bias. Conversely, where unfairness exists, there will be dissimilarity between the actual and estimated outcome values, and the residuals will be high(er).

In one embodiment, whether measured dissimilarity is sufficient to warrant a conclusion that the ML tool is unfair may be determined by an analysis of the differences between the actual and estimated values for the test set of outcomes. For example, the analysis may be performed by a fault detection model such as a sequential probability ratio test (SPRT) analysis. Also, in one embodiment, whether measured dissimilarity is so low (and measured similarity so high) as to warrant a conclusion that the ML tool is affirmatively fair (null hypothesis H₀) may also be determined by a SPRT analysis of the residuals (differences) between the actual and estimated values for the test set of outcomes. In this way, the absence of bias in a model can thus be empirically and verifiably certified. Therefore, the absence of bias certification/detection of presence of bias may be performed autonomously. Additional detail on determining whether the ML tool is fair (null hypothesis H₀, ML tool is producing outcomes fairly with respect to a demographic classification) or unfair (alternative hypothesis H₁, ML tool is producing outcomes unfairly with respect to the demographic classification) is discussed below, for example with reference to blocks 380-390 of method 300. In one embodiment, the activities of process block 220 are performed by bias detector 115.

At process block 225, fairness assessment method 200 generates an electronic alert that the ML tool generates outcomes that are biased or unfair with respect to the demographic classification. In one embodiment, the fairness assessment method 200 generates an electronic alert (such as electronic alert 160) that the ML tool does or does not generate unfair outcomes. In one embodiment, the alert will indicate the demographic classification (such as sex, age, ethnicity, etc.) that is at a root cause of the unfairness. In one embodiment, the electronic alert includes a confidence factor that the ML tool is or is not generating unfair outcomes (for example as discussed with reference to process block 380-390 of FIG. 3). In one embodiment, the electronic alert triggers an automatic action, such as automatically notifying specific individuals, generating a user interface for display of the alert, modifying the ML tool, or other action. At the conclusion of process block 225, fairness assessment method 200 continues to END block 230, where fairness assessment method 200 concludes. In one embodiment, the activities of process block 225 are performed by alert generator 120.

Thus, in one embodiment, at the conclusion of fairness assessment method 200, the presence of unfairness (if any) in the ML tool with respect to a particular demographic classification has been detected. This process may be repeated to detect unfairness (if any) in the ML tool for additional demographic classifications, for example as described in detail with reference to fairness assessment method 300 below.

### —Example Fairness Assessment Method—Confirming Fairness—

FIG. 2B illustrates another embodiment of a fairness assessment method 240 associated with fairness assessment for continuous decision evaluations of machine learning outcomes. In fairness assessment method 240, ML fairness assessment techniques are applied to confirm or certify fairness, that is, the absence of bias, in an ML tool under test.

In one embodiment, a computer system configured by computer-executable instructions to execute functions of fairness assessment system 100 executes fairness assessment method 240. In one embodiment, fairness assessment method 240 initiates at START block 241 in response to occurrence of a condition (such as those described above with reference to fairness assessment method 200) indicating that that fairness assessment method 240 should commence, and proceeds to block 242.

At block 242, fairness assessment method 240 uses a machine learning tool to assign outcomes for transactions. The machine learning tool is a target of analysis for bias, in other words, the ML tool is being checked to determine whether or not bias or unfairness is present in outcomes assigned by the ML tool. In one embodiment, the outcomes may be assigned in a manner similar to that described in process block 210 for using the ML tool to generate outcomes. In one embodiment, the activities of process block 242 are performed by ML tool configurator 105.

At block 243, fairness assessment method 240 compares transaction outcomes assigned by the ML tool for one demographic class with estimates for the transaction outcomes by a bias detection model trained for another demographic class. More particularly, assigned outcomes for a test portion of the transactions that has a first demographic classification are compared with estimated outcomes for the test portion of the transactions. The estimated outcomes are generated by an ML bias detection model that is trained to produce the estimated outcomes consistent with the assigned outcomes for a reference portion of the transactions that has a second demographic classification. The comparison is performed, for example, as described below with reference to block 375-380 of method 300 and under the heading “Overview of Multivariate ML Anomaly Detection”, or in a manner similar to that described above for process block 215. In one embodiment, the activities of process block 243 are performed by estimate comparator 110.

At block 244, fairness assessment method 240 detects that bias is absent from the ML tool. The detection is based on similarity between the assigned outcomes and the estimated outcomes for the test portion of the transactions. The similarity is evaluated, for example, as described below with reference to blocks 380-390 of method 300. and under the heading “Overview of Multivariate ML Anomaly Detection”, or in a manner similar to that described above for process block 220. In one embodiment, the activities of process block 244 are performed by bias detector 115.

At block 245, fairness assessment method 240 generates an electronic alert that the ML tool is confirmed to be free of bias with respect to the first demographic classification. In one embodiment, this alert is produced in a manner similar to that described above for process block 225. In one embodiment, the alert may be presented as a certification that the ML tool is free of bias regarding a particular demographic class (in this case, the demographic class for the transactions used to train the ML bias detection model, referred to as the “second demographic classification”). Blocks 242-243 may be repeated for multiple demographic classes, allowing the alert to be a report that includes certifications that the ML tool to be unbiased with respect to the multiple demographic classes. In one embodiment, the activities of process block 225 are performed by alert generator 120. Fairness assessment method 240 then concludes at end block 246.

### —Example Fairness Assessment Method—Deciding Between Bias and Non-Bias—

FIG. 2C illustrates another embodiment of a fairness assessment method 260 associated with fairness assessment for continuous decision evaluations of machine learning outcomes. In fairness assessment method 260, ML fairness assessment techniques are applied to decide and report whether the ML tool under test is biased (unfair), free of bias (fair), or undetermined with respect to a demographic class.

In one embodiment, a computer system configured by computer-executable instructions to execute functions of fairness assessment system 100 executes fairness assessment method 260. In one embodiment, fairness assessment method 260 initiates at START block 261 in response to occurrence of a condition (such as those described above with reference to fairness assessment method 200) indicating that that fairness assessment method 260 should commence, and proceeds to block 262.

At process block 262, fairness assessment method 260 assigns outcomes for transactions with an ML tool that is being checked for bias. In one embodiment, fairness assessment method 260 obtains or accesses outcomes that were generated by an ML tool for a set of transactions. In other words, fairness assessment method locates and retrieves from storage outcomes that were previously generated by the ML tool. In one embodiment, the transactions include at least a first set of transactions associated with a first demographic category and a second set of transactions associated with a second demographic category. In one embodiment, a transaction may be associated with a demographic category by providing an indication of the demographic category in a data structure that represents the transaction, for example by providing a field for specifying the demographic category. As discussed herein, the demographic categories may be represented by one or more metadata parameters or categorical variables included in a data structure representing a transaction. The transactions may occasionally be referred to herein as “test transactions” because the transactions are used during the test of whether or not the ML tool exhibits biased or non-biased outcomes. In one embodiment, the outcomes may be assigned or generated by the ML tool in a manner similar to that described in process blocks 210 and 242. In one embodiment, the activities of process block 262 are performed by ML tool configurator 105.

At process block 263, fairness assessment method 260 trains a bias detection model on the test transactions that belong to a first demographic category. The bias detection model is trained to estimate outcomes that are consistent with the assigned outcomes for the first demographic category. In one embodiment, fairness assessment method 260 trains a bias detection model on the first set of transactions that are associated with the first demographic category. The bias detection model is trained to estimate outcomes that are consistent with the outcomes that were generated for the first set of transactions that are associated with the first demographic category. In one embodiment, the training of the bias detection model is performed, for example, as described below with reference to block 365 of method 300 and under the heading “Overview of Multivariate ML Anomaly Detection”, or in a manner similar to that described above for process block 215. In one embodiment, the activities of process block 263 are performed by estimate comparator 110.

At process block 264, fairness assessment method 260 generates outcome estimates with the bias detection model for the test transactions that belong to a second demographic category. In one embodiment, fairness assessment method 260 inputs the second set of transactions that are associated with the second demographic category into the trained bias detection model to generate outcome estimates. The outcome estimates are generated by the bias detection model, for example, as described below with reference to block 375 of method 300 and under the heading “Overview of Multivariate ML Anomaly Detection”, or in a manner similar to that described above for process block 215. In one embodiment, the activities of process block 264 are performed by estimate comparator 110.

Comparison of the ML-tool-assigned outcomes and bias-detection-model-generated outcome estimates reveals the presence or absence of bias in the ML tool with respect to the first and second demographic categories. As discussed in further detail herein, both sets of outcomes (the outcomes generated by the ML tool for the first set of transactions and the outcome estimates for the second set of transactions) are statistically equivalent where bias is absent, and not statistically equivalent where bias is present. At process block 265, fairness assessment method 260 determines a status of bias for the ML tool. The status of bias is determined based on a dissimilarity between (1) the outcome estimates for the second set of transactions that were generated by the bias detection model, and (2) the actual outcomes generated for the second set of transactions by the ML tool. In other words, the status of bias is determined based on a dissimilarity between (1) the outcome estimates (by the bias detection model) for the test transactions that belong to the second demographic category and (2) the assigned outcomes (by the ML tool) for the test transactions that belong to the second demographic category. In one embodiment, the dissimilarity is established based on residuals between the estimated and assigned outcomes. For example, whether the dissimilarity of the residuals indicates the estimated and assigned outcomes to be statistically non-equivalent may be determined by by executing a binary fault detection test (e.g., SPRT) on the residuals. Examples of a binary fault detection test are described below under the headings “Example Framework for Fairness Assessment—Binary Hypothesis Fault Detection” and “Overview of Multivariate ML Anomaly Detection”. In one embodiment, the activities of process block 265 are performed by bias detector 115.

In one embodiment, the status of bias for the ML tool may indicate that (1) the ML tool found to be biased (or is unfair) for a specified confidence factor or level; (2) the ML tool is found not to be biased not biased (or is fair) for the specified confidence factor; or (3) the ML tool has not been found to be biased or unbiased within the specified confidence factor. Based on the determination by the binary fault detection test, the ML tool may be assigned a biased or “unfair” status of bias, an unbiased or “fair” status of bias, or an undecided status of bias. The ML tool may thus be labeled as biased, unbiased, or undetermined. In one embodiment, the status of bias may indicate that bias (unfairness) is present in the ML tool where sufficient dissimilarity is found between the estimated and actual (ML tool-assigned) outcomes. In one embodiment, sufficient dissimilarity may be established where a detection index generated by the SPRT satisfies an acceptance threshold for bias (as discussed in further detail below). In one embodiment, the status of bias may indicate that no bias (fairness) is present in the ML tool where sufficient similarity is found between the estimated and actual outcomes. In one embodiment, sufficient similarity may be established where a detection index generated by the SPRT satisfies an acceptance threshold for non-bias (as discussed in further detail below). In one embodiment, the status of bias may indicate that a determination between bias and non-bias in the machine learning tool cannot be made with sufficient confidence. This status arises when neither of the acceptance thresholds for bias or non-bias are yet satisfied (as discussed in further detail below) and more observations are required before any decision can be made.

At process block 266, fairness assessment method 260 generates an electronic alert that reports the status of bias in the ML tool. In one embodiment, this alert is produced in a manner similar to that described above for process blocks 225 and 245. Method 260 then completes at END block 267. In one embodiment, the generation of the electronic alert in block 260 is performed by alert generator 120.

In one embodiment, at a high level, the fairness assessment methods operate to detect bias in an ML tool by detecting where similar transactions have different results where demographic categories differ. In an unbiased ML tool, similar transactions should have similar results regardless of demographic category. Therefore, in one embodiment, the fairness assessment methods train a bias detection model to generate outcomes that are consistent with outcomes for a first demographic category without reference to the first demographic category. In other words, the bias detection model is trained to produce outcomes that approximate what would be produced for the first demographic category without taking into account that the transactions used for training are limited to transactions associated with the first demographic category. So, outcomes assigned by the ML tool and outcome estimates provided by the bias detection model for transactions associated with a second demographic category should be statistically equivalent, provided that no bias exists in the ML tool between the first and second demographic categories. If the outcomes and outcome estimates are not statistically equivalent, then the demographic category has an effect on the outcomes, which means that bias is present.

### —Further Embodiments of Example Fairness Assessment Method—

In one embodiment, comparing actual values (for example as described above in process blocks 215, 243, and 265) further includes executing a fault detection test on residuals between the actual values and the estimated values to produce a detection index. In other words, the fault detection test is executed on residuals between the outcome estimates and the assigned outcomes. The assigned outcomes are outcomes that are actually assigned to transactions by the ML tool. The estimated outcomes are outcomes that are predicted or otherwise generated by the ML bias detection model (e.g., MSET). The outcome estimates and the assigned outcomes are for test transactions that belong to a given demographic category.

In one embodiment, a fault detection test is then executed to produce a detection index. For example, the fault detection test (such as SPRT) is executed on residuals between the assigned outcomes and the estimated outcomes for the test portion of the transactions to produce the detection index. The detection index represents a dissimilarity between the outcome estimates and the assigned outcomes for the test transactions that belong to the demographic category. For example, the detection index quantifies the dissimilarity between outcomes produced for transactions by the ML tool and the estimated outcomes generated for those transactions as a reference.

In one embodiment, the detection index is used to establish whether or not there is bias or unfairness in the ML tool. Or, the detection index may be used to confirm that the ML tool is free of bias or is fair with respect to one or more demographic classifications. In one embodiment, detecting the unfairness (or bias) in the machine learning tool (for example as in process blocks 220 and 265) further includes determining that the detection index satisfies an acceptance threshold for the presence of bias or unfairness. And, confirming fairness or detecting that bias is absent from the ML tool (for example as in process blocks 244 and 265) further includes determining that the detection index satisfies an acceptance threshold for the absence of bias or unfairness. In one embodiment, the detection index is checked to see if the detection index satisfies either of two conditions: (i) whether a first acceptance threshold for detecting a presence of bias is satisfied is evaluated; and (ii) whether a second acceptance threshold for confirming an absence of bias is satisfied is evaluated. Then, the status of bias is set to indicate that there is bias in the ML tool when the first acceptance threshold is satisfied, and the status of bias is set to indicate that there is no bias in the ML tool when the second acceptance threshold is satisfied. Additional detail on using fault detection to test for the presence of bias (unfairness) or confirm the absence of bias (fairness) is described below under the headings “Example Framework for Fairness Assessment—Binary Hypothesis Fault Detection” and “Demonstrating Counterfactual Fairness with Fault Detection”.

Thus, in one embodiment, comparing actual values (for example as in process blocks 215, 243, and 265) may be performed at least in part by executing a fault detection test on residuals between actual values (assigned by the ML tool under test) for outcomes and estimated values (generated by the ML bias detection model) for the outcomes to produce a detection index. And, detecting the unfairness or presence of bias (for example as in process blocks 220 and 265) in the machine learning tool under test may be performed at least in part by determining that the detection index satisfies an acceptance threshold for the presence of bias. Or, confirming fairness or the absence of bias in the machine learning tool under test (for example as in process blocks 244 and 265 may be performed at least in part by determining that the detection index satisfies another acceptance threshold for the absence of bias.

And, in one embodiment, determining whether or not there is bias in the ML tool (in other words, discovering whether the ML tool is fair or unfair) includes generating residuals between the outcome estimates and assigned outcomes. Then, a fault detection test is executed on the residuals between the outcome estimates and the assigned outcomes for the test transactions to produce a detection index. The test transactions belong to one of two demographic categories. The detection index represents the dissimilarity. Whether the detection index satisfies either of two acceptance thresholds is then evaluated. Whether the detection index satisfies a first acceptance threshold for detecting presence of bias (detecting unfairness) is checked. And, whether the detection index satisfies a second acceptance threshold for confirming absence of bias (confirming fairness) is checked.

Also, in one embodiment, comparing assigned outcomes includes executing a fault detection test on residuals between assigned outcomes (generated by the ML tool) and estimated outcomes (generated by the ML bias detection model) for a test portion of the transactions. Executing the fault detection test produces a detection index. Detecting that bias is absent from the ML tool (that is, the ML tool is fair) includes determining that the detection index satisfies an acceptance threshold for the absence of bias. Or, detecting that bias is present in the ML tool (in other words, the ML tool is unfair) includes determining that the detection index satisfies an acceptance threshold for the presence of bias.

In one embodiment, the acceptance threshold for the presence of bias is set based on a pre-specified confidence factor. And, in one embodiment, the acceptance threshold for the absence of bias is set based on a pre-specified confidence factor. In one embodiment, the pre-specified confidence factor may be the same for both the presence and the absence of bias. In one embodiment, there may be two different pre-specified confidence factors for the presence and absence of bias. The confidence factors may be independently set or specified by a user or the system before executing the fault detection test. In one embodiment, determining whether or not there is bias further includes accepting, retrieving, or otherwise accessing a first confidence factor for detection of bias and setting the first acceptance threshold based on the first confidence factor for detection of bias. And, determining whether or not there is bias further includes accepting, retrieving, or otherwise accessing a second confidence factor for confirmation of absence of bias and setting the second acceptance threshold based on the second confidence factor for confirmation of absence of bias.

In one embodiment, the fault detection test is a sequential probability ratio test (SPRT). Fairness assessment method then further includes generating a log-likelihood ratio. The log-likelihood ratio is between likelihood of presence of bias and likelihood of the absence of bias. The log-likelihood ratio resulting from the generation is used as the detection index. In one embodiment, the log-likelihood ratio used as a detection index is a cumulative sum of log-likelihood ratios for individual residuals over a range of one or more of the residuals. Thus, in one embodiment, the log likelihood ratio is a cumulative log-likelihood ratio-a running total of log-likelihood ratios for a series or sequence of the residuals.

In one embodiment, a root cause of the unfairness is determined. In other words, where bias is detected in the ML tool, a root cause of the bias is determined. The root cause may be reported in the electronic alert. In one embodiment, the fairness assessment method considers several distinct potential causes for a detected unfairness. Root cause identification is discussed in further detail below, for example under the heading “Identifying Root Cause of Unfairness”.

In one embodiment, the test subset of the outcomes and the reference subset of the outcomes are discrete from one another. That is, the test transactions that belong to the first demographic category (used to train the ML bias detection model) and the test transactions that belong to the second demographic category (used to check for bias with regard to the differences in demographic categories) are discrete from one another. Sets (for example, sets of transactions) that are described herein as discrete from one another do not overlap or are mutually exclusive with respect to the items in the sets.

In one embodiment, the machine learning model (also referred to as a bias detection model) used for detecting bias or unfairness in an ML tool is a multivariate state estimation technique model. Thus, in one embodiment, the bias detection model is a multivariate state estimation technique model.

In one embodiment, a fairness assessment method further identifies a trend regarding detection of bias in the ML tool. The trend may be included in the electronic alert. In one embodiment, the trend is a trend toward detection of bias. In one embodiment, the trend is a trend away from detection of bias. In one embodiment, the trend is measured from a prior version of the ML tool to the version of the ML tool that is currently under test for bias. The results of tests to detect bias or confirm absence of bias may be recorded or stored (for example, as a data structure). The results may then be referred back to in subsequent analyses. The record of results for a fairness assessment or test of the ML tool may indicate a detection of bias (unfairness) for the configuration (or trained state) as tested for the ML tool (alternative hypothesis H₁ is satisfied), Or, the record of results may indicate a confirmation of the absence of bias (fairness) for the configuration as tested for the ML tool (null hypothesis H₀ is satisfied). Or, the record of results may indicate a that the configuration of the ML tool as tested is neither clearly biased nor unbiased (neither H₀ nor H₁ are satisfied). The underlying detection index used to determine whether bias is present or not present may also be included in the record of results. In one embodiment, the trend analysis is based on a change in the detection index between one or more previous tests of the ML tool and a current test of the ML tool. For example, increasing values for the detection index indicate a trend towards increased unfairness or bias, while decreasing values for the detection index indicate a trend towards decreased bias. An indication of increasing or decreasing bias may thus be determined and included in the alert. The extent of the change in the detection index—such as a percentage increase or decrease from the prior value to the current value of the detection index—may be calculated and included in the alert.

In one embodiment, the ML bias detection model (used to produce estimates of outcomes that would be produced by the ML tool) is a non-linear, non-parametric (NLNP) regression model. In one embodiment, the ML bias detection model is a multivariate state estimation technique (MSET) model. Additional detail on types of

In one embodiment, before generating outcomes for transactions with the machine learning tool (e.g., before assigning outcomes for test transactions with an ML tool that is being checked for bias), a fairness assessment method (such as methods 200, 240, 260, or 300) detects a change to the machine learning tool. In this way, the initiation of the method is controlled based on whether the machine learning tool has been updated. For example, the fairness assessment method may detect that the machine learning tool has undergone a training/retraining operation, and in response, launch or start the process to determine whether the retraining has introduced bias to the ML tool, or confirm that the retrained ML is free of bias. Thus, in one embodiment, a fairness assessment method is performed in response to detecting the change to the ML tool. The detection of a change such as retraining to the ML tool thus automatically triggers a check on whether the retraining has introduced bias into the ML tool.

### —Identifying Root Cause of Unfairness—

In one embodiment, a fairness assessment system performs early detection and rigorous root cause analyses (RCAs) to identify unfairness, inequity, or bias in output of an ML tool such as a causal or Bayesian network. Such early detection and RCAs have, absent the fairness assessment systems and methods described herein, been very difficult to achieve with other techniques. The fairness assessment system leverages information known as categorical variables (CatVars) that are present in the metadata in the same database as the time series signals to identify the exact individual categorical variable (CatVar) or combination of CatVars that are responsible for any skew in output time series distributions that may be deemed unfair or inequitable. Where an exact CatVar or combination of CatVars are not definitely identifiable as a cause for a lack of fairness (e.g., when the cause may be outside the system entirely, called exogenous influences), the fairness assessment system still narrows down the possibilities to various causes of unfairness. The CatVars may also be referred to herein as “metadata features”.

Causes of unfairness include, for example:
the observer effect, in which an ML tool alters or interferes with data being processed;
inadequate variable coverage, in other words, there are too few metrics measured by an ML tool;
correlations (e.g., when there are CatVars that might be directly or indirectly associated with unfairness, such as proclaimed or inferred ethnicity, gender, pronouns, pregnancy status, state, street address, zip code, first or last names, veteran status, proclaimed or inferred age, or proclaimed or inferred political party); and
sensitive attribute dependencies (e.g., where there may be no correlation with independent CatVar attributes, but there may be a dependency discovered for a combination of 2 or more sensitive attributes).

In one embodiment, whether the unfairness is correlated with outcomes for a single demographic class (categorical variable) is considered. This is indicated where the subset used for training the bias detection model is defined by a uniform or same value for one categorical variable. If so, then the fairness assessment method may report that the transactions associated with the single demographic class used to train the ML tool has caused bias in the ML tool. For example, if unfairness is detected when the bias detection method is trained using outcomes for African-Americans, and unfairness is detected using outcomes for Asian-Americans and Native Americans, the transactions for African-Americans used to train the ML tool are likely the source of the bias.

If a single demographic class of transactions used to train the ML tool is not the root cause of the bias, then the fairness assessment method considers whether there are dependencies between categorical variables. For example, the fairness assessment method determines whether the combination of two (or more) categorical variables to define a demographic (such as the combination of “male” and “veteran”) shows bias that is not present in these demographic classes individually. This may be determined by comparing the results of the fairness assessment on the individual classes with the results of the fairness assessment on the combined classes. If the combined classes show bias while the individual classes do not, then the fairness assessment method may report that the demographic classes interfere with each other or are dependent on each other.

In one embodiment, once the root cause of the unfairness has been determined, the ML tool under evaluation is automatically adjusted with respect to the root cause to mitigate the unfairness. In other words, where bias is detected in the ML tool, automatically adjust the ML tool under evaluation with respect to the root cause to reduce the bias. In one embodiment, before the automatic adjustment, the fairness assessment method detects that the unfairness or bias was introduced to the ML tool by a training operation applied to the ML tool. For example, where an ML tool has transitioned into a biased state regarding a demographic class following training, the fairness system may initiate an automatic reversion of the ML tool to a previous version that was certified fair with respect to the demographic class (or, at least, to a previous state not known to be biased with respect to the demographic class). In another example, the fairness assessment system may retrieve a training set that caused the ML tool to be configured in the biased state, remove from the training set the training features (or other training parameters for the ML tool) associated with the demographic class where bias was introduced into the ML tool, and retrain the ML tool with the remaining training features that were not associated with the affected demographic class. The retrained ML tool may then be reassessed to confirm the absence of bias. In yet another example, subsets of one or more of the training features belonging to the affected demographic class may be removed from the training set, the ML tool retrained with the remaining training features, and the retrained ML tool assessed for fairness again to determine whether the bias is resolved.

—Demonstrating Counterfactual Fairness with Fault Detection—

In one embodiment, the fairness assessment systems and methods described herein provide the first machine learning system able to answer “what if” queries as required by counterfactual fairness. Counterfactual fairness is a method of demonstrating fairness that ensures outcomes are the same for a factual situation for an individual and a counterfactual situation where the individual has different CatVars (that is, belongs to a different demographic classification) than in the factual situation. In one embodiment, the aspect of counterfactual fairness is integrated into the overall data flow of the fairness assessment systems and methods described herein. In one embodiment, ML tools (such as causal networks or causal graphs, also called “Bayesian networks” for some time series use cases) being evaluated for fairness may be incorporated into a data flow that tests the ML tool in counterfactual scenarios. The ML tool (such as a causal graph/network) can be tested experimentally and invalidated if the ML tool does not conform to the data.

In one embodiment of the fairness assessment systems and methods described herein, the ML tools (such as causal graphs/networks) are not evaluated by criteria falling inside or outside a decision boundary. Instead, in one embodiment, an innovative binary hypothesis sequential probability ratio test (SPRT) is incorporated in a quantitative decision evaluation of fairness (or unfairness). Counterfactual fairness or unfairness are demonstrable by application of a binary-hypothesis fault detection test such as SPRT to residuals between expected outcomes for a demographic class and outcomes assigned by the ML tool under test. In one embodiment, applying SPRT for determining fairness brings a mathematically provable advantage of ultra-low Type-I (false alarm probability (FAP)) false positive fairness decision and Type-II (missed alarm probability (MAP)) false negative fairness decision misidentification probabilities.

Additionally, incorporating SPRTs into fairness decisions framework allows outcomes or results of ML tools to be determined to be fair, or not fair due to an identifiable cause with a sufficient degree of confidence to make the determination meaningful. With every iteration, SPRT will make a decision implicating one of three conclusions. First, (1) Null Hypothesis H₀ which means no bias occurs in the outcomes of the ML tool, with a pre-specified quantitative confidence factor. In other words, the Null Hypothesis H₀ is that no detectable bias is present. Second, (2) Alternative (or bias) Hypothesis H₁ which means that bias is detected in the outcomes of the ML tool and attributable to one or more identified CatVars, also with a pre-specified quantitative confidence factor. In other words, the Alternative Hypothesis H₁ is that bias is clearly present. Finally, (3) Neither Null Hypothesis H₀ nor Alternative Hypothesis H₁ is implicated, which means that there is insufficient data (e.g., in a database of transactions and ML tool outcomes) to conclude (1) or (2) with sufficient confidence to meet the pre-specified quantitative confidence factor. The pre-specified confidence factor(s) may be provided or set in advance of executing the binary hypothesis test in order to specify a degree of certainty for making determinations of the presence or the absence of bias. In one embodiment, as the database of transactions and outcomes of the ML tool continues to grow and new data becomes available, the binary hypothesis SPRT will continuously be re-applied with every new incoming row of observations.

In one embodiment, the fairness assessment systems and methods described herein synergistically combine three kinds of techniques for ensuring fairness in ML models (or other ML tools): (a) the observations used for evolving the ML model can be preprocessed to ensure fairness certification in particular and requirements compliance in general; (b) the evolution of the ML model can also be modified to ensure continuous fairness requirement compliance as the database of transactions and outcomes grows with new incoming rows of observations in the future; and (c) the running of the ML model/algorithm can be continuously monitored to ensure compliance with requirements, enabling automated adjustment (post-processing) as well as enabling need for the ML model to evolve to be signaled.

In one embodiment, the latter feature (c) of continuous monitoring places the fairness assessment systems and methods described herein in compliance with an algorithmic discrimination protection best practice or principle of ongoing monitoring and mitigation. In particular, ongoing monitoring and mitigation best practice indicates that ML tools should be regularly monitored to assess algorithmic discrimination that might arise from unforeseen interactions of the system with inequities not accounted for during the pre-deployment testing, changes to the system after deployment, or changes to the context of use or associated data.

In one embodiment, for the intermediate unfolding of the database of data (transactions and ML tool outcomes) the fairness assessment systems and methods described herein tests not only for individual CatVars but also for permutations of CatVars in multiple (or all) possible combinations. It can be very valuable and computationally inexpensive to generate an expanded table schema that lists all subdivisions of the population for all individual and permuted CatVars. This can be helpful because it is possible that combinations of 2 or more CatVars might obscure an intrinsic unfairness in the outcome if processed with naïve statistical tests evaluating CatVars one-at-a-time. In this manner CatVar regressions can now very easily be applied to a pre-processed master database (of transactions and ML tool outcomes) generated during processing with the inventive nested-loop framework taught herein.

Moreover, it is possible that for large populations of subjects, there could be a high degree of churn. Churn indicates earlier subjects being deleted from the population as newer subjects are entering the population. For example, a high degree of population churn would remove a relatively large number of earlier subjects to a population (dataset) while adding a large number of newer subjects. Churn may cause fairness assessment models trained on earlier versions of a population to become obsolete. In one embodiment, for fairness assessments with a high degree of population churn, it may not be appropriate to continue fairness assessments based on new data coming in, if in fact the parameters learned previously (e.g., weeks, months, or years ago) from a (substantially) different population makeup are still being employed. For this scenario, it may be automatically detected that earlier training data is becoming obsolete due to some dynamic evolution of the population and system operators notified that it is time to re-train because the earliest entrants in the population are disappearing or otherwise no longer relevant. Additional detail on automatic detection and notification that a trained model is becoming obsolete due to evolution of a dataset is provided in U.S. patent application Ser. No. 17/368,840, filed Jul. 7, 2021 and entitled “Automatically Adapting a Prognostic-Surveillance System to Account for Age-Related Changes in Monitored Assets”.

In one embodiment, the fairness assessment systems and methods described herein can detect and quantify trends towards fairness or unfairness. Thus, even where there is not enough data yet to make the binary-hypothesis “Fairness” (null hypothesis H₀) vs. “Unfairness” (bias hypothesis H₁) determination at the pre-specified confidence factors, the fairness assessment system can report that progress is being made toward achieving compliance (but that additional data is needed).

### —Examples of Unfairness Detectable by Fairness Assessment—

A selection of examples of algorithmic inequity, bias, unfairness, financial abuse, and discrimination that could have been detected at the onset of unfairness by one embodiment of the fairness assessment systems and methods described herein is provided below. These examples are where conventional non-time-series classification tools and time-series outlier Detection tools (both univariate and multivariate) would fail, but which the fairness assessment systems and methods described herein will catch the onset of discrimination bias. For example, the detection by the fairness assessment systems and methods described herein may occur efficiently, with early detection, and ultra-low FAPs/MAPs.

While in examples (a), (b), and (c) the bias or unfairness seems evident, in one embodiment, the fairness assessment systems and methods described herein would catch the bias at its onset. For example, if the examples (a) (b) (c) started out with zero bias and then very gradually dialed in a bias, in one embodiment the fairness assessment system would detect the bias practically as soon as it was present in the transaction data. Thus, in one embodiment, the fairness assessment system would detect the following bias situations at their onset:
a) It was reported in news outlets that it was discovered that a manufacturer of disposable razors were made with identical manufacturing assets, processes, and in the same factories, but some were colored blue and some pink. Customers of the pink ones were charged 50% more than customers of the blue ones.
b) It was widely observed that the dry cleaning industry would use exactly the same processes to clean all shirts with buttons and collars. However, women having their “blouses” cleaned were charged twice as much as men having their “shirts” cleaned.
c) In early days of ECommerce, it was discovered that some large retailers would analyze browser cookies to tell if the customer was using one type or another of computing device. The user of a premium computing device would be charged 10% more for exactly the same items (with the reasoning that the users of the premium computer might have a few more dollars to spend).
d) It was discovered thru retrospective analyses of 3 years of rental statistics of a major broker of rental accommodations that the rate of acceptances/rejections for rentals was definitely correlated to FirstName-LastName tuples, leading to large class action lawsuits and huge sanctions. Now, requests to rent properties through the broker's services exclude first/last names, so property owners worldwide do not get to see the first/last names for requests to rent their properties.
e) It was discovered by a large retrospective analysis of hospital admissions for various dangerous conditions, and hospital deaths for multiple conditions, there was a distinct difference in the statistics for networks of public hospitals and the statistics for the government-administered hospitals for veterans. An audit of the government-administered hospital network uncovered a criminal practice of keeping “double books” for veterans presenting with symptoms of dangerous conditions. In actuality the actual admissions were delayed by weeks or months due to bureaucracy and mismanagement, but the fraudulent books would show all such patients being admitted promptly. The latter books were the ones presented regularly to government oversight agencies to hide the fraud, suffering, and deaths by those who served the country.
f) Large Ponzi schemes, including multi-billion-dollar cryptocurrency crashes where intelligent bad actors were very subtly incrementally altering the “collateral pool transactions” needed for cryptocurrency exchanges.
g) Equities and commodity “pump and dump” schemes resulting in billions of dollars of losses.

The above examples (d)-(g) had high-visibility but until billions of dollars disappeared, the biases or unfairness in these examples escaped detection by regulatory audits and customer (victim) due diligence. In retrospect, forensic analyses of relevant econometric time series patterns revealed subtle signatures in the chaotic populations of transactions that could have been detected and flagged early on by one embodiment of the fairness assessment systems and methods described herein. In examples where the behavior started out for weeks or years with zero bias of any kind, and then the nefarious patterns started, it would take a very long time to be discovered by conventional classification (non-time-series) such as population distribution statistical classification; or by outlier detection (time series) tools (such as threshold-based outlier detection). Partial evidence of this assertion is the tens of billions of dollars lost in well-publicized cases like examples (d)-(g).

It is important to note that the fairness assessment systems and methods described herein do not make ethical judgements about bias uncovered by a fairness assessment. A strict interpretation of “unfairness” would suggest that examples like (a), (b), and (c) are “unfair.” Conversely, another interpretation might just say those the responsible companies in examples (a), (b), and (c) are just inferring Adam Smith's “Invisible Hand” set-points on pricing, which might just be different for some different values of some CatVars. Consequently, for detecting the very subtle onset of disparities in ML tool outcomes that might gradually grow into populations of results for which there was heretofore zero bias with respect to any CatVars, the fairness assessment systems and methods described herein will, in one embodiment, detect the subtle trends with quantitative statistical power (as discussed below). Organizations that want to detect, flag, and eliminate any type of bias or “algorithmic discrimination” that could subsequently be judged to be “unfair” would benefit greatly from the statistical precision of the fairness assessment systems and methods described herein. Again, the fairness assessment systems and methods described herein provide a superior analysis approach and framework for flagging and a means to perform a root cause analysis to highlight bias in CatVar subpopulation timeseries at the earliest time, while meeting pre-designated statistical power criteria. Any judgement as to whether to actually take action to reduce, eliminate, or otherwise modify an extent of detected bias of an ML tool is deferred to organizational and societal leadership, depending on whether the flagged bias is just “good economics”, or some type of unjustifiable unfairness to or discrimination against a subpopulation. The disparity of outcome is thus revealed, enabling appropriate action to be taken, if desirable.

In one embodiment, the fairness assessment systems and methods described herein model the econometric or other socially relevant variables (including one or more CatVars) with a Multivariate State Estimation Technique (MSET) model (or other non-linear, non-parametric (NLNP) regression model). In one embodiment, modeling the econometric or other socially relevant time series data with an MSET or other NLNP model is advantageous because MSET is a deterministic mathematical algorithm and therefore reversible. In one embodiment, reversibility enables conducting rigorous traceback root cause analysis (RCA). Other ML algorithms that are based on Neural Networks (NNs) or Support Vector Machines (SVMs) cannot be used for traceback RCA because NNs and SVMs rely on stochastic optimization of weights, which is not reversible. Traceback RCA is desirable when inherent unfairness is detected in a ML tool so that an operator of the ML tool, an auditing agency, or regulatory body may identify the exact CatVar or combination of CatVars are responsible for the detected unfairness, and so that a timeline may be determined for when unfairness was introduced (if it was not always present).

### —Example Framework for Fairness Assessment—

FIG. 3 illustrates one embodiment of a fairness assessment method 300 (or framework) associated with fairness assessment for continuous decision evaluations of time series machine learning outcomes. In one embodiment, fairness assessment method 300 operates to determine whether an ML tool that is under test or evaluation (such as ML tool 125) is or is not unfair or biased.

In one embodiment, fairness assessment method 300 initiates at START block 305 in response to an fairness assessment system (such as fairness assessment system 100) determining one or more of (i) that a fairness assessment system has been instructed to evaluate the fairness of a particular ML tool; (ii) that an instruction to perform fairness assessment method 300 on an ML tool with a set of time series readings has been received (iii) a user or administrator of an fairness assessment system has initiated fairness assessment method 300; (iv) it is currently a time at which fairness assessment method 300 is scheduled to be run; or (v) that fairness assessment method 300 should commence in response to occurrence of some other condition. In one embodiment, a computer system configured by computer-executable instructions to execute functions of fairness assessment system 100 executes fairness assessment method 300. Following initiation at start block 305, fairness assessment method 300 continues to process block 310.

At process block 310, fairness assessment method 300 initializes with a data set Xₘₙₚ. The data set Xₘₙₚ has a number of observations m. In one embodiment, the observations make up a set of transactions (for example, a time series of transactions, such as set of transactions 145). At least a portion of the set of transactions are to be performed by an ML tool that is under test or evaluation for fairness. The data set Xₘₙₚ has a number of signals n. The signals indicate input variables that describe transactions in the set of transactions. The ML tool under test generates an outcome value from an observation of the n signals. The data set Xₘₙₚ has a number of metadata features p. In one embodiment, the set of metadata features is or includes the categorical variables (CatVars) for the data set Xₘₙₚ. There may be separate values given to a categorical variable on an observation-by-observation, for example, each observation may have a value for a categorical variable that is apart from values given for one or more other observations.

Process block 315 and decision block 320 provide an index and base condition for an outer loop for configuring an ML tool with various combinations of two metadata features (CatVars). At process block 315, fairness assessment method 300 initializes an outer loop index i for a first of the two metadata features to a value of 1. At decision block 320, fairness assessment method 300 determines whether the value of outer loop index i for metadata features remains below the overall number of metadata features p. Where the value of outer loop index i for metadata features remains below the overall number of metadata features p (320:True), fairness assessment method 300 proceeds to process block 325. Where the value of outer loop counter i for metadata features does not remain below the overall number of metadata features p (320:False), fairness assessment method 300 proceeds to END block 330, where fairness assessment method 300 concludes.

Process block 325 and decision block 335 provide an index and base condition for an inner loop for configuring the ML tool with the various combinations of two metadata features (CatVars). At process block 325, fairness assessment method 300 initializes an inner loop index j for a second of the two metadata features to a value of 1. At decision block 335, fairness assessment method 300 determines whether the value of inner loop index j for metadata features remains below the overall number of metadata features p. Where the value of inner loop index j for metadata features remains below the overall number of metadata features p (335:True), fairness assessment method 300 proceeds to process block 340. Where the value of inner loop index j for metadata features does not remain below the overall number of metadata features p (335:False), fairness assessment method 300 proceeds to process block 345. At process block 345, fairness assessment method 300 increments outer loop index i.

At process block 340, fairness assessment method 300 selects data to include or utilize a subset p′having two (or one where indexes i and j are equal) of the metadata features (CatVars). From a subset p′, for example, fairness assessment method 300 may create test sets of outcomes from an ML tool under test (such as ML tool 125) that are specific to a particular demographic group that makes up the subset p′. The two metadata features are selected from the set of metadata features based on the outer loop index i and inner loop index j, choosing to include the i^{th} and j^{th} of the p metadata features (more formally, i:j∈{1, 2, 3, . . . , p}). Where and i and j are equal, only one metadata feature is included in the selected data. In one embodiment, the selected data includes the input variables that describe a transaction and the chosen metadata features in vectors for a transaction, and excludes the non-chosen metadata features from the vectors. Thus, in one embodiment, fairness assessment method 300 subdivides the available data set Xₘₙₚ of transactions into sets for different combinations of categorical variables. The available data set Xₘₙₚ of transactions is thus broken down into a variety of demographic subsets (that are described by the combinations of categorical variables).

In one embodiment, the two-loop structure allows evaluation of an ML tool for unfairness with respect to one CatVar/metadata feature, or unfairness with respect to a combination of up to two CatVars/metadata features. In one embodiment, additional loops and indexes may be added to extend to combinations of additional CatVars/metadata features. Or, in one embodiment, the list of CatVars/metadata features may be extended to include combinations of the CatVars/metadata features. For example, the list of CatVars/metadata features may be Sex, Race, Age, Religion, Sex&Race, Sex&Age, Sex& Religion, Race&Age, Race&Religion, . . . , thereby allowing for further combination between subsets of CatVars/metadata features. In this way, the fairness assessment method may create demographic subsets with varying degrees of specificity.

At process block 350, fairness assessment method 300 builds or configures the ML tool X_{mnp′} to process the selected data. The ML tool X_{mnp′} is an ML tool that is under evaluation for fairness (such as ML tool 125). In one embodiment, the ML tool X_{mnp′} is a Bayesian model. In one embodiment, ML tool X_{mnp′} is configured to exclude the non-chosen metadata features from its operation. In one embodiment, ML tool X_{mnp′} is configured to operate without using the non-chosen metadata features. And, at process block 350, fairness assessment method 300 generates and configures output for the predictions (outcomes) produced for the selected data using the ML tool X_{mnp′}. These predictions or outcomes are then stored for subsequent assessment for fairness or bias.

At process block 355, fairness assessment method 300 initializes monitoring the X^{N}_{mnp′} metadata features. For example, the ML tool is executed on input variables n (for transactions that are in the demographic subset p) to produce outcome estimates or predictions for transactions that are in the demographic subset p′. N is the number of unique variables (discrete CatVars or combinations of CatVars) handled by ML tool X_{mnp′}. In other words, N is the number of discrete configurations of values for the CatVars. For example, where the CatVars (or metadata features) are sex and veteran status, N=4 combinations: (Female, Non-veteran); (Female, Veteran); (Male, Non-Veteran); and (Male, Veteran).

Process block 357 and decision block 360 provide an index and base condition for an assessment loop for determining whether the outcomes of the ML tool are unfair or biased between differing values for the CatVars (metadata features) with which the ML tool is configured. In the assessment loop, outcomes from the ML tool for one set of transactions having one combination of values for the CatVars is compared with outcomes from the ML tool for another set of transactions having another combination of values for the CatVars until a bias (unfairness) is found, or sets of transactions have been compared for all N unique configurations of values for the CatVars. For example, outcomes for Female Non-veterans may be compared with outcomes for Female Veterans, outcomes for Female Veterans may be compared with Male Non-veterans, and so on, to determine whether bias is present.

At process block 357, fairness assessment method 300 initializes an assessment loop index k for the configurations of CatVar variables to a value of 1. At decision block 360, fairness assessment method 300 determines whether the value of assessment loop index k for metadata features remains below the number of discrete configurations of values for the CatVars N. Where the value of assessment loop index k for metadata features remains below the number of discrete configurations of values for the CatVars N (360:True), fairness assessment method 300 proceeds to process block 365. Where the value of assessment loop index k for metadata features does not remain below the number of discrete configurations of values for the CatVars N (360:False), fairness assessment method 300 proceeds to process block 370. At process block 370, fairness assessment method 300 increments inner loop index j.

At process block 365, fairness assessment method 300 builds an NLNP ML anomaly detection model, such as an MSET model. The ML anomaly detection model is built using the predictions or outcomes from the ML tool X_{mnp′} for a set of transactions X_{mnp′} having the k^{th} combination of values for the CatVars. In one embodiment, to build the ML anomaly detection model, an ML anomaly detection model is trained to predict what input variables and outcomes are expected to be, for example as discussed under the heading “Overview of Multivariate ML Anomaly Detection” below. In one embodiment, the ML anomaly detection model is trained using the input variable values and the outcome values for the set of transactions X^{k}_{mnp′} having the k^{th} combination of values for the CatVars. In one example, the ML anomaly detection model is trained with the set of transactions for Female Non-veterans, and not with the transactions for Female Veterans, Male Non-veterans, or Male Veterans.

At process block 375, fairness assessment method 300 monitors the predictions (outcomes) for a set of transactions X^{k+1}_{mnp′} having the k+1^{th} combination of values for the CatVars with the ML anomaly detection model (e.g., MSET model) that was trained with the input values and predictions (outcomes) for the set of transactions X^{k}_{mnp′} having the k^{th} combination of values for the CatVars. In one embodiment, the ML anomaly detection model produces estimates of what the predictions or outcomes of the ML tool X_{mnp′} is expected to be for the transactions in X^{k+1}_{mnp′} based on the input values for the transactions in X^{k+1}_{mnp′}. For example, the ML anomaly detection model estimates what the outcomes of transactions for Female Veterans are using a model trained to estimate outcomes of transactions for Female Non-Veterans. If the ML tool is fair (no bias), distributions of the actual outcomes and estimated outcomes should not substantially differ. If the ML tool is unfair (has bias), distributions of the actual outcomes and estimated outcomes will differ.

—Example Framework for Fairness Assessment—Binary Hypothesis Fault Detection—

At process block 380, fairness assessment method 300 compares the distributions of (1) the estimated outcomes generated by the ML anomaly detection model (or bias detection tool) for predictions by the ML tool X_{mnp′} and (2) the actual outcomes (or predictions) assigned by the ML tool X_{mnp′}. In one embodiment, where the ML tool X_{mnp′} is fair (unbiased), the distributions of the estimated and actual outcomes should be similar despite differing configurations k and k+1. For example, in one embodiment, where a combined distribution of the estimated and actual outcomes is unimodal, the ML tool X_{mnp′} is non-biased or fair. In one embodiment, the ML tool X_{mnp′} is fair where the combined distribution of the estimated and actual outcomes is approximately Gaussian (for example, with a kurtosis between 2 and 4). In one embodiment, the ML tool X_{mnp′} is fair where skewness is approximately 0 for the combined distribution of the estimated and actual outcomes.

In one embodiment, the comparison of the distributions of estimates is performed by a binary hypothesis SPRT analysis of the distributions. In one embodiment, as discussed above at process blocks 355-380, time series sequences of outcomes (e.g., price charged, loan application approval rate, job offers extended (after normalization for multivariate factors using MSET)) for transactions are split, divided or separated based on metadata factors (CatVars). SPRT is used as a binary-hypothesis decision tool to evaluate whether there is a difference between time series sequences of outcomes that are split based on metadata factors (alternative or bias hypothesis H₁) or there is no statistical difference in outcome sequences when split based on metadata factors (null or non-bias hypothesis H₀).

As used herein, the term “statistically equivalent” in reference to two sets of outcomes indicates that the two sets of outcomes are substantially unimodal in a combined distribution, and are therefore not statistically different. Statistical equivalence or non-equivalence of actual outcomes assigned by an ML tool and estimated outcomes assigned by a bias detection model may be established by performance of the binary hypothesis fault detection test as discussed below. Thus, the null hypothesis H₀ may also be considered a statement that outcomes generated by an ML tool for a first demographic category and outcomes generated by the ML tool for a second demographic category are statistically equivalent. The alternative hypothesis H₁ may also be considered a statement that outcomes generated by an ML tool for a first demographic category and outcomes generated by the ML tool for a second demographic category are not statistically equivalent.

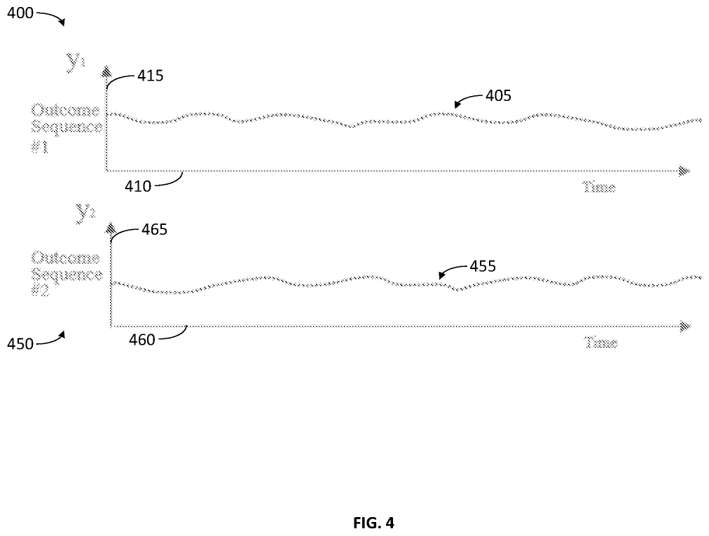

FIG. 4 illustrates two plots of time series of outcomes, a first plot 400 for outcome sequence #1 and a second plot 450 for outcome sequence #2. Outcomes 405 are plotted against a time axis 410 and an outcome value y₁ axis 415. Similarly, outcomes 455 are plotted against a time axis 460 and an outcome value y₂ axis 465. For example, outcomes 405 may represent actual outcome values generated by ML tool Xmpp for a time series of transactions X^{k+1}_{mnp′} that have the combination of CatVar values k+1. And, outcomes 455 may represent estimated outcome values generated by an ML anomaly detection model trained with a time series of transactions X^{k}_{mnp′} (that have the combination of CatVar values k) and corresponding outcomes produced by ML tool X_{mnp′}. A discrete difference function Yₖ provides a distribution of the differences between the actual outcomes of ML tool X_{mnp′} made for transactions with CatVar values k+1 and the estimated outcomes made as if the ML tool X_{mnp′} was operating on transactions with CatVar values k. The discrete difference function is given in Eq. 1 below:

$${Y}_{q} = {y}_{1} ( {t}_{q} ) - {y}_{2} ( {t}_{q} ) \qquad Eq . 1$$

where q is a time index for the time series. Where there is no bias between the subdivisions of the time series by CatVar values (under the null hypothesis H₀), Y_{q} will be distributed about a mean of 0. Where there is bias between the subdivisions of the time series by CatVar values (under the alternative or bias hypothesis H₁), the distribution of Y_{q} will not be about a mean of 0.

In one embodiment, blocks 380 and 385 are implemented with a binary hypothesis fault detection test (such as a binary hypothesis SPRT test) to distinguish between the null hypothesis H₀ (indicating fairness or no bias with reference to a CatVar) and the alternative or bias hypothesis H₁ (indicating unfairness or bias with reference to a CatVar). The binary hypothesis SPRT provides a quantitative framework that enables decision between two hypotheses at a given statistical power or confidence level. The null hypothesis H₀ is that in the distribution Y_{q}, Y_{q} is gaussian with mean 0 and variance σ². Null hypothesis H₀ indicates lack of bias in the ML tool with respect to differing values of a CatVar. The alternative (bias) hypothesis H₁ is that in the distribution Y_{q}, Y_{q} is gaussian with mean M other than 0 (M≠0) and variance σ². Alternative hypothesis H₁ indicates the presence of bias in the ML tool with respect to differing values of a CatVar.

In one embodiment, the procedure for determining between the null (H₀) and alternative (H₁) hypotheses is to compute a value of SPRT for each new transaction (for example in order of time index q) until an acceptance threshold for one of the two hypotheses is satisfied. The formula for SPRT for a sequence of n observations is given in Eq. 2, below:

$$SPRT = \frac{M}{{σ}^{2}} {\sum }_{q = 1}^{n} {Y}_{q} \qquad Eq . 2$$

where M is the mean of the alternative (i.e., faulted) distribution (assumes the mean of the null un-faulted distribution has been pre-normalized to zero), σ² is the value of the variance of the residuals during training, and Y_{q} is the value of the residual at the current timestamp. The output SPRT is a log-likelihood ratio, which may also be referred to as a “SPRT index”, as discussed below. The SPRT index is one example of an index for quantifying differences or dissimilarity between two sets of values in the context of fault or anomaly detection (such indexes may be referred to generally herein as “detection indexes”). Thus, in one embodiment, dissimilarity is expressed based on the residuals or differences between actual outcomes assigned by an ML tool under test and estimates for the outcomes that are generated by a bias detection model.

The log-likelihood ratio compares the likelihoods of the two competing hypotheses H₀ and H₁ by taking the logarithm of the ratio of the likelihoods of the absence of bias and the presence of bias The log-likelihood ratio SPRT can also be expressed mathematically as SPRT=ln(L₀/L₁)=ln(L₀)−ln(L₁), where L₀ represents the likelihood of null hypothesis H₀ (the absence of bias) and L₁ represents the likelihood of alternative hypothesis H₁ (the presence of bias). Thus, in one embodiment, a positive SPRT indicates that H₀—the absence of bias—is more likely, and a negative SPRT indicates that H₁—the presence of bias—is more likely.

Acceptance thresholds are applied to ensure determination of the presence or absence of bias to a pre-determined level of confidence. The acceptance threshold for the null (no bias) hypothesis H₀ is SPRT less than or equal to a constant B (SPRT≤ B). The acceptance threshold for the alternative (bias) hypothesis H₁ is SPRT greater than or equal to a constant A (SPRT≥ A). Where SPRT is between B and A, no conclusion is reached, and additional transactions are needed to determine whether there is bias. The acceptance thresholds are related to error (misidentification) probabilities by the following expressions:

$$A = ln ( \frac{β}{1 - α} ) \qquad Eq . 3$$

$$B = ln ( 1 - ( \frac{β}{α} ) ) \qquad Eq . 4$$

In Eqs. 3 and 4, α is the probability of deciding H₀ when H₁ is true, and β is the probability of deciding H₁ when H₀ is true. Put another way, if SPRT<B, the values in Y come from a distribution where the mean is not equal to the test distribution (that is, a biased distribution), with probability (1−α). One can therefore conclude, with confidence factor (1−α), that one variable is out of tolerance, indicating bias with respect to that variable. If SPRT<A, then the values in Y come from a distribution where the mean is equal to the mean of the test distribution (that is, an unbiased distribution), with probability (1−β). One can therefore conclude, with confidence factor (1−β), that the variable is not out of tolerance, indicating no bias with respect to that variable.

In one embodiment, statistical power of the test for whether a ML tool is fair is configurable by users or administrators of the fairness assessment systems and methods described herein. β, the probability of deciding H₁ when H₀ is true, is also known as the probability of a Type II error or “false negative”. 1−β is the probability of a “true positive”, in other words, the probability of correctly rejecting the null hypothesis H₀ in favor of the alternative hypothesis H₁. 1−β is also known as the power of the test. α, the probability of deciding H₀ when H₁ is true, is also known as the probability of a Type I error or “false positive”. 1−α is the probability of a “true negative”, in other words, correctly not rejecting the null hypothesis. Adjusting the parameters α and β controls the acceptance thresholds for the null (no bias) hypothesis H₀ and alternative (bias) hypothesis H₁. Thus, a user or administrator may control how strongly outcomes must indicate bias (or lack of bias) in an ML tool before deciding that the ML tool incorporates bias.

At process block 385, fairness assessment method 300 determines whether the distributions are fair (unbiased) or unfair (biased) between the actual outcomes and estimated outcomes. For example, the determination may be made by determining whether or not the combined distributions are unimodal, as discussed above. Or for example, the determination may be made based on the results of the binary hypothesis SPRT analysis discussed above.

Where the combined distribution of the estimates by ML anomaly detection model for predictions (outcomes) by the ML tool X_{mnp′} and the actual predictions (outcomes) by the ML tool X_{mnp′} is not unimodal (or is otherwise indicated to include bias by SPRT analysis) (385:False), the ML tool X_{mnp′} contains bias, and processing continues at process block 390. At process block 390, fairness assessment method 300 indicates that ML tool X_{mnp′} contains bias. For example, fairness assessment method 300 may generate an electronic alert that indicates that ML tool X_{mnp′} contains bias (for example as described below under the heading “Electronic Alerts”). Where the combined distribution is unimodal (or is otherwise indicated not to include bias by SPRT analysis) (385:True), the ML tool X_{mnp′} either contains no bias or there is insufficient data to determine whether there is bias, and processing continues at process block 395. At process block 395, assessment index k is incremented, and processing returns to decision block 360.

At the completion of fairness assessment method 300, it has been determined whether or not an ML tool (for example, a Bayesian model) includes bias with respect to a categorical variables (for example representing classes of persons).

### Alternate Embodiment

In a further embodiment, fairness assessment as described herein may be used to detect where an ML tool is improperly considering demographic classifications that are accessible to or provided to the ML tool. In many applications, an ML tool generally will not have access to the metadata parameters or categorical variables that indicate demographic classifications associated with a transaction. But, it is possible that in some applications, an ML tool will be provided with variables or metadata that represent demographic classifications associated with a transaction. Bias may be detected in such configurations by comparing the transaction outcomes produced by the ML tool with demographic classifications present and with demographic classifications removed. In one embodiment, a fairness assessment method accesses a first set of outcomes for a set of transactions that were generated by the ML tool. The first set of outcomes were generated for the set of transactions with the demographic classifications for the transactions provided to the ML tool. The fairness assessment method also accesses a second set of outcomes for the set of transactions that were generated by the ML tool. The second set of outcomes were generated for the set of transactions with the demographic classifications for the transactions hidden from the ML tool. The demographic classifications may be hidden from the ML tool by providing NULL values for the demographic classifications, providing a same value for the demographic classification of each transaction, or otherwise not providing the ML tool with demographic classification information for a transaction. The ML tool will thus be unable to differentiate transactions based on demographic classification.

The first and second sets of outcomes may then be analyzed for dissimilarity and the ML tool assigned a status of bias, for example detecting a presence of bias or certifying an absence of bias as described herein with reference to FIGS. 2A-2C. For example, the first and second sets of outcomes may be examined with the binary hypothesis fault detection test described above under the heading “Example Framework for Fairness Assessment— Binary Hypothesis Fault Detection” to determine whether the residuals between the first and second sets of outcomes satisfy acceptance thresholds for either of (1) absence of bias or (2) presence of bias. An electronic message including an alert of bias or certification of the absence of bias, respectively, may then be generated and transmitted for presentation.

### Selected Advantages

In one embodiment, the fairness assessment systems and methods described herein improve the technology of automation, AI, or ML tools or techniques by enabling automatic detection of when and in what way an automation, AI, or ML tool or technique is unfair, inequitable, or otherwise biased. In one embodiment, the fairness assessment systems and methods described herein improve the technology of automation, AI, or ML tools or techniques by enabling existing time series Machine Learning (ML) algorithms to be subjected to continuous quantitative fairness or bias characterization, post-analysis auditability, and precise root-cause explain-ability. In one embodiment, the fairness assessment systems and methods described herein improve the technology of automation, AI, or ML tools or techniques by detecting and exposing hidden or emerging unfairness, inequity, or other bias in the outcomes of automation, AI, or ML tools or techniques at the onset of the bias.

The foregoing description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

### —Overview of Multivariate ML Anomaly Detection—

In general, multivariate ML modeling techniques used for ML anomaly detection predict or estimate what each signal should be or is expected to be based on the other signals in the database. The predicted signal may be referred to as the “estimate”. A multivariate ML anomaly detection model is used to make the predictions or estimates for individual variables based on the values provided for other variables. For example, for Signal (variable) 1 in a database of N signals (variables), the multivariate ML anomaly detection model will compute an estimate for Signal (variable) 1 using signals (variables) 2 through N.

Therefore, in one embodiment, the vectors of input provided to the ML bias detection model include the input variables for the ML tool under test, and the outcome(s) produced from those variables by the ML tool under test. While the multivariate anomaly detection model may be configured to produce estimates for the input variables of the ML tool as well as estimates of the outcomes, for the purposes of fairness assessment/bias detection, the estimates provided by the bias detection model for the outcomes produced by the ML tool are of primary interest, while the estimates generated by the bias detection model for the values input to the ML tool may generally be disregarded for the purposes of bias detection.

In one embodiment, the ML anomaly detection model (that is, the ML bias detection model) may be a non-linear non-parametric (NLNP) regression algorithm used for multivariate anomaly detection. Such NLNP regression algorithms include auto-associative kernel regression (AAKR), and similarity-based modeling (SBM) such as the multivariate state estimation technique (MSET) (including Oracle's proprietary Multivariate State Estimation Technique (MSET2)). In one embodiment, the ML anomaly detection model may be another form of algorithm used for multivariate anomaly detection, such as a neural network (NN), Support Vector Machine (SVM), or Linear Regression (LR).

The ML anomaly detection model is trained to produce estimates of what the values of variables should be based on training with time series readings (such as time series vectors or time series signals) that represent normal or correct operation of a monitored asset. To train the ML anomaly detection model, the time series readings are used to adjust the ML anomaly detection model. A configuration of correlation patterns between the variables of the ML anomaly detection model is automatically adjusted based on values of the time series readings so as to cause the ML anomaly detection model to produce accurate estimates for each variable based on inputs to other variables. Sufficient accuracy of estimates to conclude determine the ML anomaly detection model to be sufficiently trained may be determined by residuals-a residual is a difference between an actual value (such as a measured, observed, sampled, or resampled value) and an estimate, reference, or prediction of what the value is expected to be—being minimized below a pre-configured training threshold. At the completion of training, the ML anomaly detection model has learned correlation patterns between variables.

Following training, the ML anomaly detection model may be used to monitor time series readings. Subtracting an actual, measured value for each signal from a corresponding estimate gives the residuals or differences between the values of the signal and estimate. Where there is an anomaly in a signal, the measured signal value departs from the estimated signal value. This causes the residuals to increase, triggering an anomaly alarm. Thus, the residuals are used to detect such anomalies where one or more of the residuals indicates such a departure, for example by becoming consistently excessively large.

In one embodiment, the processor executes a fault detection model to detect bias in the ML tool under test, as discussed in detail above. In one embodiment, the fault detection model uses the sequential probability ratio test (SPRT) to detect anomalous deviations (or faults) in the outcomes assigned by the ML tool under test. The SPRT detects the presence (or confirms the absence) of bias by calculating a cumulative sum of the log-likelihood ratio for each successive residual between the outcome values assigned by the ML tool under test, and estimated values produced by the bias detection (e.g., MSET) model. Then, the SPRT compares the cumulative sum against (i) a bias acceptance threshold to determine whether a fault (bias/unfairness) is detected, and (ii) against a no-bias acceptance threshold to confirm whether no fault (bias/unfairness) is present. Where the bias acceptance threshold is satisfied, an anomalous bias or unfairness is detected in the ML tool under test. Where the no-bias acceptance threshold is satisfied, anomalous bias or unfairness is confirmed to be absent from the ML tool under test. Where either threshold is crossed, an alert may be generated that indicates a status of whether there is, or is not, bias present in the ML tool under test.

### —Electronic Alerts—

In one embodiment, an electronic alert is generated by composing and transmitting a computer-readable message. The computer readable message may include content describing unfairness or bias of an ML tool, such as categorical variables (for example representing classes of persons) for which the ML tool produces unfair outcomes to transactions. In one embodiment, an electronic alert may be generated and sent in response to a detection of a biased ML tool (that produces unfair outcomes). The electronic alert may be composed and then transmitted for subsequent presentation on a display or other action.

In one embodiment, the electronic alert is a message that is configured to be transmitted over a network, such as a wired network, a cellular telephone network, wi-fi network, or other communications infrastructure. The electronic alert may be configured to be read by a computing device. The electronic alert may be configured as a request (such as a REST request) used to trigger initiation of a function in response to detection of the biased ML tool, such as triggering a retraining of the ML tool. The electronic alert may be presented in a user interface such as a graphical user interface (GUI) by extracting or otherwise parsing the content of the electronic alert by a REST API (or other software interface) that has received the electronic alert.

### —Cloud or Enterprise Embodiments—

In one embodiment, the present system (such as fairness assessment system 100) is a computing/data processing system including a computing application or collection of distributed computing applications for access and use by other client computing devices that communicate with the present system over a network. In one embodiment, fairness assessment system 100 is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, fairness assessment system 100 is a centralized server-side application that provides at least the functions disclosed herein and that is accessed by many users by way of computing devices/terminals communicating with the computers of fairness assessment system 100 (functioning as one or more servers) over a computer network. In one embodiment fairness assessment system 100 may be implemented by a server or other computing device configured with hardware and software to implement the functions and features described herein.

In one embodiment, the components of fairness assessment system 100 may be implemented as sets of one or more software modules executed by one or more computing devices specially configured for such execution. In one embodiment, the components of fairness assessment system 100 are implemented on one or more hardware computing devices or hosts interconnected by a data network. For example, the components of fairness assessment system 100 may be executed by network-connected computing devices of one or more compute hardware shapes, such as central processing unit (CPU) or general-purpose shapes, dense input/output (I/O) shapes, graphics processing unit (GPU) shapes, and high-performance computing (HPC) shapes.

In one embodiment, the components of fairness assessment system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of fairness assessment system 100 may (i) generate or compose an electronic message or signal to issue a command or request to another component, (ii) transmit the message or signal to other components of fairness assessment system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by fairness assessment system 100, for example through a web interface server. In one embodiment, the remote computing system may send requests to and receive responses from fairness assessment system 100. In one example, access to the information or applications may be effected through use of a web browser on a personal computer or mobile device. In one example, communications exchanged with fairness assessment system 100 may take the form of remote representational state transfer (REST) requests using JavaScript object notation (JSON) as the data interchange format for example, or simple object access protocol (SOAP) requests to and from XML servers. The REST or SOAP requests may include API calls to components of fairness assessment system 100.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### —Computing Device Embodiment—

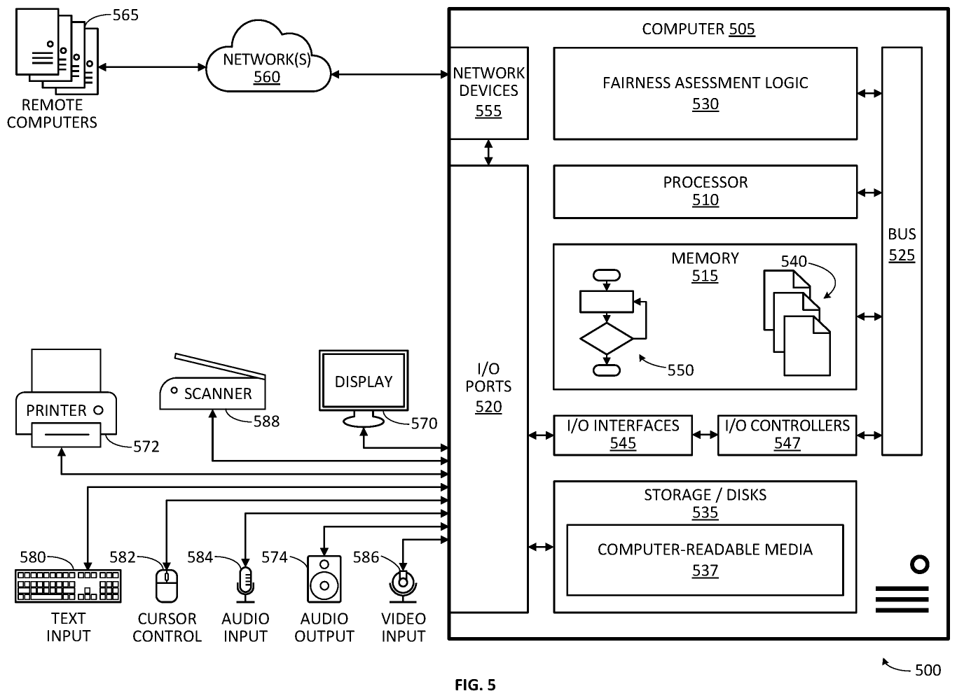

FIG. 5 illustrates an example computing system 500 that is configured and/or programmed as a special purpose computing device(s) with one or more of the example systems and methods described herein, and/or equivalents. The example computing system 500 may include a computer 505 that includes at least one hardware processor 510, a memory 515, and input/output ports 520 operably connected by a bus 525. In one example, the computer 505 may include fairness assessment logic 530 configured to facilitate fairness assessment for continuous decision evaluations of machine learning outcomes similar to logic, systems, methods, and other embodiment shown in and described with reference to FIGS. 1, 2, 3, and 4.

In different examples, the logic 530 may be implemented in hardware, a non-transitory computer-readable medium 537 with stored instructions, firmware, and/or combinations thereof. While the logic 530 is illustrated as a hardware component attached to the bus 525, it is to be appreciated that in other embodiments, the logic 530 could be implemented in the processor 510, stored in memory 515, or stored in disk 535.

In one embodiment, logic 530 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate fairness assessment for continuous decision evaluations of machine learning outcomes. The means may also be implemented as stored computer executable instructions that are presented to computer 505 as data 540 that are temporarily stored in memory 515 and then executed by processor 510.

Logic 530 may also provide means (e.g., hardware, non-transitory computer-readable medium that stores executable instructions, firmware) for performing fairness assessment for continuous decision evaluations of machine learning outcomes.

Generally describing an example configuration of the computer 505, the processor 510 may be a variety of various processors including dual microprocessor and other multi-processor architectures. A memory 515 may include volatile memory and/or non-volatile memory. Non-volatile memory may include, for example, ROM, PROM, and so on. Volatile memory may include, for example, RAM, SRAM, DRAM, and so on.

A storage disk 535 may be operably connected to the computer 505 via, for example, an input/output (I/O) interface (e.g., card, device) 545 and an input/output port 520 that are controlled by at least an input/output (I/O) controller 547. The disk 535 may be, for example, a magnetic disk drive, a solid state disk drive, a floppy disk drive, a tape drive, a Zip drive, a flash memory card, a memory stick, and so on. Furthermore, the disk 535 may be a CD-ROM drive, a CD-R drive, a CD-RW drive, a DVD ROM, and so on. The memory 515 can store a process 550 and/or a data 540, for example. The disk 535 and/or the memory 515 can store an operating system that controls and allocates resources of the computer 505.

The computer 505 may interact with, control, and/or be controlled by input/output (I/O) devices via the input/output (I/O) controller 547, the I/O interfaces 545, and the input/output ports 520. Input/output devices may include, for example, one or more displays 570, printers 572 (such as inkjet, laser, or 3D printers), audio output devices 574 (such as speakers or headphones), text input devices 580 (such as keyboards), cursor control devices 582 for pointing and selection inputs (such as mice, trackballs, touch screens, joysticks, pointing sticks, electronic styluses, electronic pen tablets), audio input devices 584 (such as microphones or external audio players), video input devices 586 (such as video and still cameras, or external video players), image scanners 588, video cards (not shown), disks 535, network devices 520, and so on. The input/output ports 520 may include, for example, serial ports, parallel ports, and USB ports.

The computer 505 can operate in a network environment and thus may be connected to the network devices 555 via the I/O interfaces 545, and/or the I/O ports 520. Through the network devices 555, the computer 505 may interact with a network 560. Through the network, the computer 505 may be logically connected to remote computers 565. Networks with which the computer 505 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method, comprising:
generating outcomes for transactions with a machine learning (ML) tool;
comparing actual values for a test subset of the outcomes with estimated values generated for the test subset of the outcomes by a machine learning model, wherein the test subset is associated with a test value for a demographic classification, and wherein the machine learning model is trained with a reference subset of the outcomes that is associated with a reference value for the demographic classification;
detecting the unfairness in the machine learning tool based on dissimilarity between the actual values and the estimated values for the test subset of the outcomes; and
generating an electronic alert that the ML tool generates outcomes that are unfair with respect to the demographic classification.

2. The computer-implemented method of claim 1,
wherein comparing actual values further comprises executing a fault detection test on residuals between the actual values and the estimated values to produce a detection index; and
wherein detecting the unfairness in the machine learning tool further comprises determining that the detection index satisfies an acceptance threshold for the presence of bias.

3. The computer-implemented method of claim 2, further comprising setting the acceptance threshold for the presence of bias based on a pre-specified confidence factor.

4. The computer-implemented method of claim 1, further comprising:
determining a root cause of the unfairness;
detecting that the unfairness was introduced to ML tool by a training operation; and
automatically adjusting the ML tool with respect to the root cause to mitigate the unfairness.

5. The computer-implemented method of claim 1, further comprising, before generating outcomes for transactions with the machine learning tool:
detecting a change to the machine learning tool; and
in response to detecting the change to the machine learning tool, performing the steps of generating outcomes for transactions with the machine learning tool, comparing actual values for a test subset of the outcomes with estimated values generated for the test subset of the outcomes, detecting the unfairness in the machine learning tool, and generating an electronic alert.

6. The computer-implemented method of claim 1, wherein the test subset of the outcomes and the reference subset of the outcomes are discrete from one another.

7. The computer-implemented method of claim 1, wherein the machine learning model is a multivariate state estimation technique model.

8. One or more non-transitory computer-readable media that includes stored thereon computer-executable instructions that when executed by at least a processor of a computer system cause the computer system to:
accessing outcomes that were generated by an ML tool for a set of transactions, wherein the transactions include at least a first set of transactions associated with a first demographic category and a second set of transactions associated with a second demographic category;
train a bias detection model on the first set of transactions associated with the first demographic category, wherein the bias detection model is trained to estimate outcomes that are consistent with the outcomes that were generated for the first set of transactions associated with the first demographic category;
input the second set of transactions associated with the second demographic category into the bias detection model to generate outcome estimates;
determine a status of bias for the ML tool based on a dissimilarity between the outcome estimates for the second set of transactions generated by the bias detection model and the outcomes generated for the second set of transactions by the ML tool; and
generate an electronic alert that reports the status of bias for the ML tool.

9. The non-transitory computer-readable medium of claim 8, wherein the instructions to determine a status of bias for the ML tool further cause the computer to:
execute a fault detection test on residuals between the outcome estimates and the outcomes for the second set of test transactions associated with the second demographic category to produce a detection index that represents the dissimilarity;
evaluate whether the detection index satisfies either of (i) a first acceptance threshold for detecting a presence of bias and (ii) a second acceptance threshold for confirming an absence of bias; and
setting the status of bias to indicate that there is bias in the ML tool when the first acceptance threshold is satisfied and setting the status of bias to indicate that there is no bias in the ML tool when the second acceptance threshold is satisfied.

10. The non-transitory computer-readable medium of claim 9, wherein the instructions to determine a status of bias for the ML tool further cause the computer to:
access a first confidence factor for detection of bias;
setting the first acceptance threshold based on the first confidence factor for detection of bias;
access a second confidence factor for confirmation of absence of bias;
setting the second acceptance threshold based on the second confidence factor for confirmation of absence of bias.

11. The non-transitory computer-readable medium of claim 9, wherein the fault detection test is a sequential probability ratio test, further comprising generating a log-likelihood ratio between likelihood of presence of bias and likelihood of the absence of bias to be the detection index.

12. The non-transitory computer-readable medium of claim 8, wherein the instructions further cause the computer to:
identify a trend regarding detection of bias in the ML tool; and
include the trend in the electronic alert.

13. The non-transitory computer-readable medium of claim 8, wherein the instructions further cause the computer to:
where bias is detected in the ML tool, determine a root cause of the bias; and
include the root cause in the electronic alert.

14. The non-transitory computer-readable medium of claim 8, wherein the instructions further cause the computer to, before assigning outcomes for test transactions with an ML tool that is being checked for bias, detect a change to the machine learning tool.

15. The non-transitory computer-readable medium of claim 8, wherein the test transactions that belong to the first demographic category and the test transactions that belong to the second demographic category are discrete from one another.

16. A computing system, comprising:
at least one processor;
at least one memory connected to the at least one processor;
one or more non-transitory computer readable media including instructions stored thereon that when executed by at least the processor cause the computing system to:
use a machine learning tool to assign outcomes for transactions, wherein the machine learning tool is a target of analysis for bias;
compare assigned outcomes for a test portion of the transactions that has a first demographic classification with estimated outcomes for the test portion of the transactions, wherein the estimated outcomes are generated by an ML bias detection model that is trained to produce the estimated outcomes consistent with the assigned outcomes for a reference portion of the transactions that has a second demographic classification;
detect that bias is absent from the ML tool based on similarity between the assigned outcomes and the estimated outcomes for the test portion of the transactions; and
generate an electronic alert that the ML tool is confirmed to be free of bias with respect to the first demographic classification.

17. The computing system of claim 16,
wherein the instructions to compare assigned outcomes further cause the computing system to execute a fault detection test on residuals between the assigned outcomes and the estimated outcomes for the test portion of the transactions to produce a detection index; and
wherein the instructions to detect that bias is absent from the ML tool further cause the computing system to determine that the detection index satisfies an acceptance threshold for the absence of bias.

18. The computing system of claim 17, wherein the instructions further cause the computing system to set the acceptance threshold for the absence of bias based on a pre-specified confidence factor.

19. The computing system of claim 16, wherein the test portion of the transactions and the reference portion of the transactions are discrete from one another.

20. The computing system of claim 16, wherein the bias detection model is a non-linear, non-parametric regression model.
